(19) United States
(12) Patent Application Publication
(10) Pub. No.: US 2024/0418965 A1
(43) Pub. Date: Dec. 19, 2024

(54) OPTICAL MODULE

(71) Applicant: LG INNOTEK CO., LTD., Seoul (KR)

(72) Inventor: Jae Wook JUNG, Seoul (KR)

(21) Appl. No.: 18/687,189

(22) PCT Filed: Aug. 26, 2022
(86) PCT No.: PCT/KR2022/012821

§ 371 Date: Feb. 27, 2024

(30) Foreign Application Priority Data
Aug. 27, 2021 (KR) 10-2021-0114291

(51) Int. Cl. G02B 13/00; G02B 3/00; G02B 9/60

(52) U.S. Cl. CPC G02B 13/0045; G02B 3/0087; G02B 9/60; G02B 2003/0093

(57) ABSTRACT

An optical module disclosed to an embodiment includes a sensor, and an optical system including a first lens, a second lens, a third lens, a fourth lens, and a fifth lens sequentially arranged along the optical axis in the direction from the object side to the sensor side, and at least one of the object-side and sensor-side surfaces of the fifth lens includes a freeform surface.

### TECHNICAL FIELD

An embodiment relates to an optical module capable of realizing high resolution and miniaturization.

### BACKGROUND ART

Camera modules perform the function of photographing objects and saving them as images or videos, and are installed in various applications. In particular, the camera module is manufactured in an ultra-small size and is applied to not only portable devices such as smartphones, tablet PCs, and laptops, but also drones and vehicles, providing various functions.

For example, an optical system of the camera module may include an imaging lens that forms an image, and an image sensor that converts the formed image into an electrical signal. At this time, the camera module may perform an autofocus (AF) function that automatically adjusts a distance between the image sensor and the imaging lens to align the focal length of the lens, and may focus on distant objects through a zoom lens. The zooming function of zoom up or zoom out may be performed by increasing or decreasing the magnification of the camera. In addition, the camera module adopts image stabilization (IS) technology to correct or prevent image shake caused by camera movement due to an unstable fixation device or the user's movement.

The most important element for this camera module to obtain an image is the imaging lens that forms the image. Recently, interest in high resolution has been increasing, and research using multiple lenses is being conducted to realize this. In addition, research using a plurality of imaging lenses with positive (+) or negative (−) refractive power is being conducted to realize high resolution.

In addition, recently, as the front display of smartphones equipped with a camera module is required, the form factor of the front camera is continuously changing, and as a result, an under-display camera that hides the front camera under the display is being applied.

However, when the camera is placed at the bottom of the display, problems such as deterioration in image quality of the camera module, reduction in brightness, and occurrence of ghosts/flares occur due to loss of light due to the display panel. In particular, as brightness drops to 20% of the existing level, a new optical structure that can compensate for the brightness of the camera is required.

Therefore, an optical system with a new structure that may have improved resolution and improved illuminance regardless of the position of the camera is required.

[Disclosure] [Technical Problem]

The embodiment provides an optical system that has improved resolution, improved illuminance, and improved optical characteristics and may be miniaturized.

### Technical Solution

A camera module according to an embodiment of the invention includes a sensor; and an optical system including a first lens, a second lens, a third lens, a fourth lens, and a fifth lens sequentially arranged along an optical axis in a direction from an object side to a sensor side, and at least one of an object-side and sensor-side surfaces of the fifth lens includes a freeform surface,

the fifth lens satisfies the following equation A:

$$\vert max Sag\_O \_x \_ 5 \vert \neq \vert max Sag\_O \_y \_ 5 \vert \qquad [ Equation A ]$$

(In Equation A, max |Sag_O_x_5| means an absolute value of the maximum Sag value in an X-axis direction on the object-side surface of the fifth lens, and max |Sag_O_y_5| means an absolute value of the maximum Sag value in a Y-axis direction on the object-side surface of the fifth lens.)

The optical system satisfies the following equations 1 to 3:

$$60 ° \leq FOV \leq 90 ° \qquad [ Equation 1 ]$$

(FOV in Equation 1 means field of view.)

$$0.50 \leq TTL / ImgH \leq 1. \qquad [ Equation 2 ]$$

(In Equation 2, TTL means a distance in the optical axis direction from a vertex of an object-side surface of the first lens to an image surface of the image sensor unit, and ImgH means twice a diagonal distance from the image surface of the image sensor unit overlapping the optical axis to the 1.0 field region of the image sensor.)

$$CA\_O \_x < CA\_O \_ 5 \qquad [ Equation 3 ]$$

(In Equation 3, CA_O_x means an effective diameter of an object-side surface of a lens closest to an aperture stop among the lenses between the aperture stop and the sensor, and CA_O_5 means to an effective diameter of the object-side surface of the fifth lens.).

### Advantageous Effects

The optical system and camera module according to the embodiment may have improved optical characteristics. In detail, the optical system may have improved aberration characteristics, resolution, etc. as a plurality of lenses have a set shape, refractive power, thickness, interval, etc.

Additionally, the optical system and camera module according to the embodiment may have improved distortion and aberration control characteristics and may have good optical performance not only in a center portion but also in a peripheral portion of the field of view (FOV).

Additionally, the optical system according to the embodiment may have improved optical characteristics and a small TTL (Total track length), so the optical system and the camera module including the same may be provided in a slim and compact structure.

In addition, the embodiment includes five lenses sequentially arranged along the optical axis in the direction from the object side to the sensor side, and at least one of the object-side and sensor-side surfaces of the fifth lens among the five lenses may be formed as a freeform surface.

In detail, at least one of the object-side and sensor-side surfaces of the fifth lens may have a Sag value and a change value of the Sag value defined by equations, and free-form shape of at least one of the object-side and sensor-side surfaces of the fourth lens may defined by a Sag value and a change value of the Sag value defined by the above equations.

Accordingly, when light passes through the fifth lens and moves to the image sensor unit, a relative illumination of the light incident on the image sensor unit may be improved. In detail, the relative illumination of the light passing through the fifth lens and incident on the image sensor unit may be 30% or more. In detail, the relative illumination of the light passing through the five lenses and incident on the image sensor unit may be 35% or more. In detail, the relative illumination of the light passing through the five lenses and incident on the image sensor unit may be 45% or more.

Therefore, the camera module including the optical system may compensate for the decrease in light quantity that may vary depending on the position of the display device. That is, the camera module including the optical system may secure a sufficient amount of light of brightness without being affected by the position of the display device, thereby implementing improved resolution.

Therefore, the optical system according to the embodiment may increase an amount of light incident on the image sensor unit while maintaining the size of the lenses and improved optical characteristics without enlarging an aperture of the lenses, in order to increase the amount of light incident on the image sensor unit.

Additionally, the optical module according to the embodiment may implement miniaturization of the optical system and optical module by using a fifth lens having a freeform surface.

In detail, the optical module according to the embodiment may improve the relative illumination while reducing the size of the optical system and optical module.

When there is no fifth lens including a freeform surface, TTL (distance in the optical axis direction between the first lens and the image sensor unit) of the optical system must be increased in order to improve the relative illumination, but the optical module according to the embodiment controls the moving direction of light by the fifth lens including the free curved surface, thereby improving the ambient light amount ratio without increasing the TTL.

That is, the optical module according to the embodiment may reduce the size of TTL by 10% to 20% compared to the optical module that does not include the fifth lens including a freeform surface. Accordingly, the optical module may be miniaturized, and the optical module may be easily applied to various display devices.

Additionally, the optical module according to the embodiment may have improved MTF and improved resolution by a fifth lens having a freeform surface.

In detail, the optical module according to the embodiment may have improved MTF characteristics by increasing the amount of light incident on the image sensor unit through the fifth lens having a freeform surface.

In addition, the optical module according to the embodiment improves the peripheral light amount ratio of the light incident on the image sensor unit, thereby preventing a decrease in resolution due to post-correction after image acquisition.

In other words, an optical module that does not include a lens with a freeform surface has a low relative illumination of the image sensor unit, so a post-correction process is required to obtain the image through the image sensor unit and then to be implemented, and the resolution of the optical module may be degraded in this post-correction process.

However, the optical module according to the embodiment increases the relative illumination of the image sensor unit by using a lens having a freeform surface, and as a result, post-correction is not required or resolution is not significantly reduced due to the post-correction process, so it may have improved resolution.

### DESCRIPTION OF DRAWINGS

FIG. 1 is a diagram illustrating the configuration of an optical system and an optical module according to an embodiment.

FIGS. 2 and 3 are diagrams for explaining the object-side surface of the fifth lens of the optical system and the optical module according to the embodiment.

FIGS. 4 and 5 are diagrams for explaining the sensor-side surface of the fifth lens of the optical system and the optical module according to the embodiment.

FIGS. 6 and 7 are graphs for explaining Sag values at various angles of the fifth lens of the optical system and the optical module according to the embodiment.

FIG. 8 is a diagram for explaining a slope angle of the lens of the optical system and optical module according to an embodiment.

FIG. 9 is a diagram showing a configuration of an optical system and an optical module according to the first embodiment.

FIG. 10 is a table for explaining the lenses of the optical system and optical module according to the first embodiment.

FIG. 11 is a table explaining the fifth lens of the optical system and the optical module according to the first embodiment.

FIG. 12 is a table for explaining the fifth lens of the optical system and the optical module according to the embodiment.

FIG. 13 is a table explaining specific values of the optical system and optical module according to the first embodiment.

FIGS. 14 to 18 are tables for explaining the slope angle, interval, thickness, Sag value, and aspheric coefficient of the lenses of the optical system and optical module according to the first embodiment.

FIG. 19 is a graph showing distortion of the optical system and optical module according to the first embodiment.

FIG. 20 is a table for explaining a MTF characteristics of the optical system and optical module according to the first embodiment.

FIG. 21 is a diagram showing the configuration of an optical system and an optical module according to the second embodiment.

FIG. 22 is a table for explaining the lenses of the optical system and optical module according to the second embodiment.

FIG. 23 is a table explaining the fifth lens of the optical system and the optical module according to the second embodiment.

FIG. 24 is a table explaining specific values of the optical system and optical module according to the second embodiment.

FIGS. 25 to 29 are tables for explaining the slope angle, interval, thickness, Sag value, and aspherical coefficient of the lenses of the optical system and optical module according to the second embodiment.

FIG. 30 is a graph showing distortion of the optical system and optical module according to the second embodiment.

FIG. 31 is a table for explaining a MTF characteristics of the optical system and optical module according to the second embodiment.

FIG. 32 is a diagram showing the configuration of an optical system and an optical module according to the third embodiment.

FIG. 33 is a table for explaining the lenses of the optical system and optical module according to the third embodiment.

FIG. 34 is a table explaining the fifth lens of the optical system and the optical module according to the third embodiment.

FIG. 35 is a table explaining specific values of the optical system and optical module according to the third embodiment.

FIGS. 36 to 40 are tables for explaining the slope angle, interval, thickness, Sag value, and aspherical coefficient of the lenses of the optical system and optical module according to the third embodiment.

FIG. 41 is a graph showing distortion of the optical system and optical module according to the third embodiment.

FIG. 42 is a table for explaining the MTF characteristics of the optical system and optical module according to the third embodiment.

FIGS. 43 and 44 are diagrams for explaining a display device to which an optical system and an optical module are applied according to an embodiment.

### BEST MODE

Hereinafter, preferred embodiments of the invention will be described in detail with reference to the accompanying drawings.

A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology. The terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected”, “coupled” or “joined” to another component, the description may include not only being directly connected, coupled or joined to the other component but also being “connected”, “coupled” or “joined” by another component between the component and the other component.

In the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element.

In the following description, the first lens refers to the lens closest to the object side, and the last lens (n-th lens) refers to the lens closest to the sensor side. Additionally, unless otherwise specified, the units for lens radius, effective diameter, thickness, interval, BFL (Back focal length), TTL (Total track length or Total top length), etc. are all mm.

Additionally, the shape of the lens is expressed based on the optical axis of the lens. For example, the fact that the object-side surface of the lens is convex means that a vicinity of the optical axis on the object-side surface of the lens is convex, and does not mean that a periphery of the optical axis is convex. Therefore, even if the object-side surface of the lens is described as convex, the periphery region of the optical axis on the object-side surface of the lens may be concave. In addition, “object-side surface” may refer to a surface of the lens facing the object side based on the optical axis, and “image-side surface” may be defined as a surface of the lens facing the imaging surface based on the optical axis.

Additionally, a critical point of the lens is defined as a point on the lens surface that becomes 0 during a first differentiation. In detail, the critical point may mean a point at which a slope value is 0 as a point at which a sign of the slope value with respect to the optical axis OA and the vertical direction of the optical axis OA changes from positive (+) to negative (−) or from negative (−) to positive (+). Here, the critical point is a point at which convexity and concavity are changed, and may mean a point at which a sign changes from positive (+) to negative (−) or from negative (−) to positive (+) during secondary differentiation. The critical point may be a point at which a sign of a refractive power is changed. The critical point may be a point at which a sign of a slope angle is changed.

Additionally, the Sag value of the object-side surface of the lens may be defined as a distance in the optical axis direction between an arbitrary point on the object-side surface of the lens and a contact point between the optical axis and the object-side surface of the lens. Additionally, the Sag value on the sensor-side surface of the lens may be defined as the distance in the optical axis direction between an arbitrary point on the sensor-side surface of the lens and the contact point between the optical axis and the sensor-side surface of the lens.

Additionally, the magnitude of the Sag value described below may be compared based on the absolute value of the Sag value.

In addition, in the X-axis (first direction), Y-axis (second direction), and Z-axis direction (third direction) shown in the drawing, the Z-axis direction (third direction) may be a direction parallel to the optical axis direction or the optical axis direction.

Hereinafter, for convenience of explanation, the X-axis direction (first direction) may be defined as a direction perpendicular to the Z-axis direction (third direction), and the Y-axis direction (second direction) may be defined as a direction perpendicular to the Z-axis direction (third direction).

In addition, the X-axis direction (first direction), the Y-axis direction (second direction), and the Z-axis direction (third direction) may be defined as a direction perpendicular to the same plane or another plane.

Hereinafter, an optical system according to embodiments, an optical module including the optical system, the optical system, and a camera module including the optical module will be described with reference to the drawings.

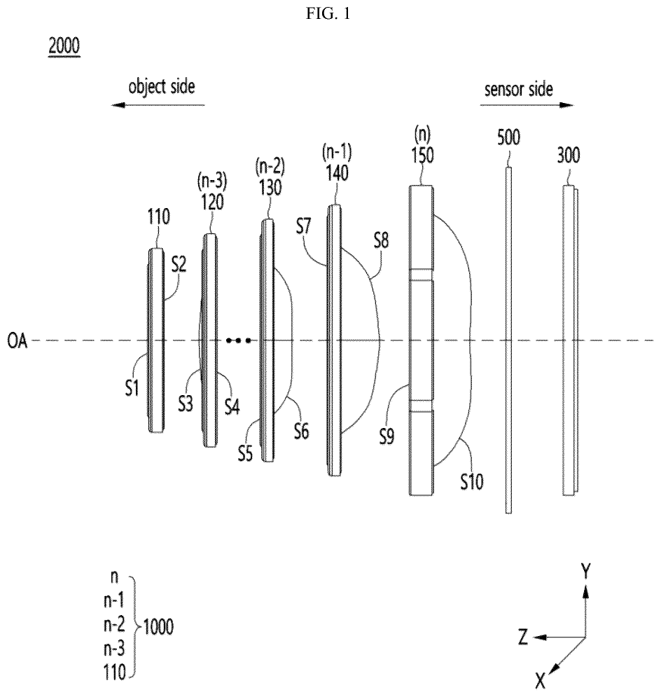

Referring to FIG. 1, an optical system 1000 according to an embodiment may include a plurality of lenses. For example, the optical system 1000 may include n lenses. In detail, the optical system 1000 may include a first lens 110 to an n-th lens (n).

In detail, the optical system 1000 may include the first lens 110 to the n-th lens (n) sequentially arranged from the object side to the sensor side. At this time, n may include a natural number of 2 or more. In detail, n may be a natural number having a value of 2 to 5.

In FIG. 1, although the optical system 1000 according to the embodiment includes five lenses: a first lens 110, a second lens 120, a third lens 130, a fourth lens 140, and a fifth lens 150, the embodiment is not limited thereto, and the optical system 1000 may include two to four lenses.

That is, when n has a value of 5 in the optical system 1000 according to the embodiment, the optical system 1000 may include a first lens, a second lens, a third lens, a fourth lens, and a fifth lens. That is, when n has a value of 5, the n−4th lens may be the first lens, the n−3th lens may be the second lens, and the n−2th lens may be the third lens, The n−1th lens may be the fourth lens, and the n-th lens may be the fifth lens.

Hereinafter, for convenience of explanation, it will be mainly described that the optical system 1000 according to an embodiment includes five lenses of the first lens 110, the second lens 120, the third lens 130, the fourth lens 140, and the fifth lens 150.

Referring to FIG. 1, the optical system 1000 may further include an image sensor unit 300 and a filter unit 500 to form an optical module 2000.

That is, the optical module 200 may include an optical system 1000 including n lenses described above, and a filter unit 500 and an image sensor unit 300 disposed in the sensor side direction of the optical system.

The first lens 110, the second lens 120, the third lens 130, the fourth lens 140, and the fifth lens 150 may be sequentially arranged along the optical axis OA of the optical system 1000.

Light corresponding to information of an object disposed on the object side may sequentially pass through the first lens 110, the second lens 120, the third lens 130, the fourth lens 140, the fifth lens 150, and the filter unit 500 to be incident on the image sensor unit 300.

The first lens 110, the second lens 120, the third lens 130, the fourth lens 140, and the fifth lens 150 may each include an effective region and an ineffective region. The effective region may be an effective diameter through which the light incident on each lens of the first lens 110, the second lens 120, the third lens 130, the fourth lens 140, and the fifth lens 150 passes. That is, the effective region may be defined as a region in which the incident light is refracted to realize optical characteristics.

The effective diameter (Effective region) of the lens may be related to the inner diameter of the spacer disposed between the lenses. That is, the effective diameter of the lens may be related to the inner diameter of the spacer disposed between the surfaces of adjacent lenses.

In detail, the effective diameter of the lens may be the same as or different from the inner diameter of the spacer disposed between the surfaces of adjacent lenses. More specifically, the effective diameter of the lens may be less than or greater than the inner diameter of the spacer disposed between the surfaces of adjacent lenses.

More specifically, the effective diameter of the lens may have a size within ±0.4 mm of the inner diameter of the spacer disposed between the surfaces of adjacent lenses. More specifically, the effective diameter of the lens may have a size within ±0.3 mm of the inner diameter of the spacer disposed between the surfaces of adjacent lenses. More specifically, the effective diameter of the lens may have a size within ±0.2 mm of the inner diameter of the spacer disposed between the surfaces of adjacent lenses. More specifically, the effective diameter of the lens may have a size within ±0.1 mm of the inner diameter of the spacer disposed between the surfaces of adjacent lenses.

Alternatively, the effective diameter of the lens may be related to the inner diameter of a flange portion of the lens on which the spacer is supported.

In detail, the effective diameter may be 2 mm or less, 1 mm or less, or 0.3 mm or less relative to the inner diameter of the flange portion.

The ineffective region may be arranged around the effective region. The ineffective region may be placed at the periphery of the effective region. That is, a region excluding the effective region of the lens may be an ineffective region. The ineffective region may be a region where the light is not incident. That is, the ineffective region may be a region unrelated to the optical characteristics. Additionally, the ineffective region may be a region fixed to a barrel (not shown) that accommodates the lens.

The optical system 1000 according to the embodiment may include an aperture stop (not shown) for controlling the amount of incident light. At least one aperture stop may be disposed between two adjacent lenses among the first lens 110, the second lens 120, the third lens 130, the fourth lens 140, and the fifth lens 150. For example, the aperture stop may be disposed between the first lens 110 and a lens closest to the first lens 110. For example, the aperture stop may be disposed between the first lens 110 and the second lens 120.

In addition, at least one lens among the first lens 110, the second lens 120, the third lens 130, the fourth lens 140, and the fifth lens 150 may serve as an aperture stop. For example, at least one of the first lens 110, the second lens 120, the third lens 130, the fourth lens 140, and the fifth lens 150 may serve as an aperture stop for controlling the amount of light on the object-side surface or the sensor-side surface of the lens. Accordingly, the overall length of the optical system may be reduced by removing the aperture stop disposed between the lenses, thereby making it possible to miniaturize the optical system.

At least one lens among the first lens 110, the second lens 120, the third lens 130, the fourth lens 140, and the fifth lens 150 may include a freeform surface on at least one surface of the lens. That is, at least one lens among the first lens 110, the second lens 120, the third lens 130, the fourth lens 140, and the fifth lens 150 may be a freeform lens.

A freeform lens having at least one surface of the lens having a freeform surface will be described in detail below.

The first lens 110 may have positive (+) refractive power on the optical axis. The first lens 110 may include plastic or glass. For example, the first lens 110 may be made of plastic.

The first lens 110 may include a first surface S1 defined as the object-side surface and a second surface S2 defined as the sensor-side surface. The first surface S1 may be convex with respect to the object side on the optical axis, and the second surface S2 may be concave with respect to the sensor side on the optical axis. That is, the first lens 110 may have an overall meniscus shape convex from the optical axis toward the object.

At least one of the first surface S1 and the second surface S2 may be an aspherical surface. For example, both the first surface S1 and the second surface S2 may be aspherical.

In the first lens 110, an effective diameter of the first surface S1 on the object-side surface and an effective diameter of the second surface S2 on the sensor-side surface may be different from each other. For example, the effective diameter of the first surface S1 of the first lens 110 may be larger than that of the second surface S2.

The second lens 120 may have negative refractive power on the optical axis. The second lens 120 may include plastic or glass. For example, the second lens 120 may be made of plastic.

The second lens 120 may include a third surface S3 defined as the object-side surface and a fourth surface S4 defined as the sensor-side surface. The third surface S3 may be convex with respect to the object side on the optical axis, and the fourth surface S4 may be concave with respect to the sensor side on the optical axis. That is, the second lens 120 may have an overall meniscus shape convex from the optical axis toward the object.

At least one of the third surface S3 and the fourth surface S4 may be an aspherical surface. For example, both the third surface S3 and the fourth surface S4 may be aspherical.

The effective diameter of the third surface S3 of the second lens 120 on the object-side surface may be different from that of the fourth surface S4 on the sensor-side surface. For example, the effective diameter of the third surface S3 of the second lens 120 may be larger than that of the fourth surface S4.

The third lens 130 may have positive (+) or negative (−) refractive power on the optical axis. The third lens 130 may include plastic or glass. For example, the third lens 130 may be made of plastic.

The third lens 130 may include a fifth surface S5 defined as the object-side surface and a sixth surface S6 defined as the sensor-side surface. The fifth surface S5 may be convex with respect to the object side on the optical axis, and the sixth surface S6 may be concave with respect to the sensor side on the optical axis. That is, the third lens 130 may have an overall meniscus shape convex from the optical axis toward the object. Alternatively, the fifth surface S5 may be convex with respect to the object side on the optical axis, and the sixth surface S6 may be convex with respect to the sensor side on the optical axis. That is, the third lens 130 may have an overall shape in which both sides are convex on the optical axis. Alternatively, the fifth surface S5 may be concave with respect to the object side on the optical axis, and the sixth surface S6 may be concave with respect to the sensor side on the optical axis. That is, the third lens 130 may have an overall shape where both sides are concave on the optical axis. Alternatively, the fifth surface S5 may be concave with respect to the object side on the optical axis, and the sixth surface S6 may be convex with respect to the sensor side on the optical axis. That is, the third lens 130 may have an overall meniscus shape convex from the optical axis toward the sensor.

At least one of the fifth surface S5 and the sixth surface S6 may be an aspherical surface. For example, both the fifth surface S5 and the sixth surface S6 may be aspherical.

In the third lens 130, an effective diameter of the fifth surface S5 on the object side and the effective diameter of the sixth surface S6 on the sensor side may be different from each other. For example, the effective diameter of the fifth surface S5 of the third lens 130 may be smaller than that of the sixth surface S6.

The fourth lens 140 may have positive (+) refractive power on the optical axis. The fourth lens 140 may include plastic or glass. For example, the fourth lens 140 may be made of plastic.

The fourth lens 140 may include a seventh surface S7 defined as the object-side surface and an eighth surface S8 defined as the sensor-side surface. The seventh surface S7 may be concave with respect to the object side on the optical axis, and the tenth surface S10 may be convex with respect to the sensor side on the optical axis. That is, the fourth lens 140 may have an overall meniscus shape convex from the optical axis toward the sensor.

At least one of the seventh surface S7 and the eighth surface S8 may be a freeform surface. That is, the fourth lens 140 may be a freeform lens.

At least one of the seventh surface S7 and the eighth surface S8 may be an aspherical surface. For example, both the seventh surface S7 and the sixth surface S8 may be aspherical.

In the fourth lens 140, an effective diameter of the seventh surface S7 on the object-side surface and an effective diameter of the eighth surface S8 on the sensor-side surface may be different from each other. For example, the effective diameter of the seventh surface S7 of the fourth lens 140 may be smaller than that of the eighth surface S8.

The fifth lens 150 may have negative refractive power on the optical axis. The fifth lens 150 may include plastic or glass. For example, the fifth lens 150 may be made of plastic.

The fifth lens 150 may include a ninth surface S9 defined as the object-side surface and a tenth surface S10 defined as the sensor-side surface. The ninth surface S9 may be concave with respect to the object side on the optical axis, and the tenth surface S10 may be concave with respect to the sensor side on the optical axis. That is, the fifth lens 150 may have an overall shape where both sides are concave on the optical axis.

The fifth lens 150 may include a critical point. In detail, at least one of the ninth surface S9 and the tenth surface S10, which are the object-side surface and the sensor-side surface of the fifth lens 150, may include a critical point. For example, the tenth surface S10 of the fifth lens 150 may include a critical point.

The effective diameter of the ninth surface S9 on the object-side surface of the fifth lens 150 may be different from the effective diameter of the tenth surface S10 on the sensor-side surface. For example, the effective diameter of the ninth surface S9 of the fifth lens 150 may be smaller than that of the tenth surface S10.

The fifth lens, which is a freeform lens, will be described in detail below.

As previously described, at least one lens among the first lens 110, the second lens 120, the third lens 130, the fourth lens 140, and the fifth lens 150 may be formed in a freeform shape.

For example, among the lenses of the optical system 1000, a lens disposed close to the image sensor unit 300 may be formed in a freeform shape. For example, the fifth lens 150 may be formed in a freeform shape. That is, when the optical system 1000 includes n lenses, the n-th lens may be formed in a freeform shape.

Hereinafter, for convenience of description, it will be mainly described that the fifth lens 150 is a freeform lens.

At least one of the ninth surface S9 and the tenth surface S10 of the fifth lens 150 may be formed in a free form shape. In detail, at least one of the ninth surface S9 and the tenth surface S10 may include a freeform surface. For example, the fifth lens 150 has one of the ninth surface S9 and the tenth surface S10 having a freeform surface, or the ninth surface S9 and the tenth surface S10 may all have a freeform surface.

The fifth lens 150 may have a double plane symmetrical shape. In detail, the fifth lens 150 may have a shape that is symmetrical to the X-Z plane and symmetrical to the Y-Z plane. Additionally, the fifth lens 150 may have a shape that is asymmetrical with respect to the X-Y plane. That is, the fifth lens 150 may have a shape that is symmetrical about the X and Y axes and asymmetrical about the Z axis.

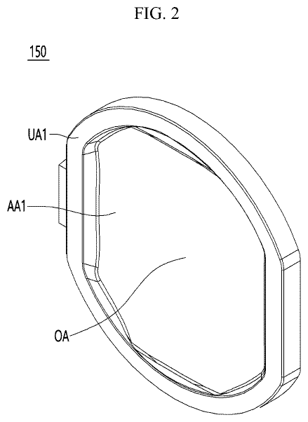

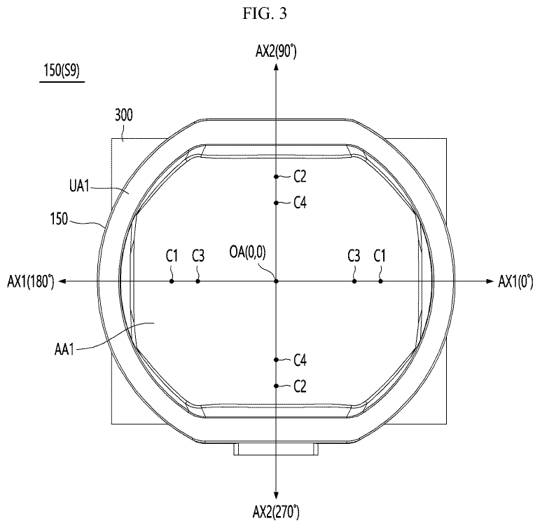

FIGS. 2 and 3 are diagrams for explaining the freeform surface of the ninth surface S9 of the fifth lens 150.

Referring to FIG. 2, the ninth surface S9 of the fifth lens 150 may include a first effective region AA1 and a first ineffective region UA1. In detail, the ninth surface S9 of the fifth lens 150 may include the first effective region AA1, which is a region through which light incident on the fifth lens 150 passes. Light incident on the fifth lens 150 may be refracted in the first effective region AA1 of the ninth surface S9 of the fifth lens 150 to implement optical characteristics.

Additionally, the ninth surface S9 of the fifth lens 150 may include a first ineffective region UA1, which is a region through which light incident on the fifth lens 150 does not pass. Light incident on the fifth lens 150 may not pass through the first ineffective region UA1 of the fifth lens 150. Accordingly, the first ineffective region UA1 of the ninth surface S9 may be unrelated to the optical characteristics of light incident on the fifth lens 150. Additionally, a portion of the first ineffective region UA1 may be fixed to the barrel accommodating the fifth lens 150.

Referring to FIG. 3, a virtual axis for setting the coordinates of the ninth surface S9 of the fifth lens 150 may be set.

In detail, a first axis AX1 and a second axis AX2 may be set on the ninth surface S9 of the fifth lens 150. The first axis AX1 may be defined as a direction parallel to the longitudinal direction of the long axis of the image sensor unit 300. That is, the first axis AX1 may be defined as an axis that passes through the optical axis OA and extends in a direction parallel to the long axis of the image sensor unit 300.

Additionally, the second axis AX2 may be defined as a direction parallel to the minor axis longitudinal direction of the image sensor unit 300. That is, the second axis AX2 may be defined as an axis that passes through the optical axis OA and extends in a direction parallel to the minor axis of the image sensor unit 300.

For example, the first axis AX1 may be defined as the X-axis direction and may be defined as an axis having angles of 0° and 180° with respect to the optical axis OA. Additionally, the second axis AX2 may be defined as the Y-axis direction and may be defined as an axis having angles of 90° and 270° with respect to the optical axis OA.

However, the embodiment is not limited to this, and the first axis may be defined as the Y-axis direction, and the second axis may be defined as the X-axis direction. Hereinafter, for convenience of explanation, the description will focus on the case where the first axis AX1 is defined in the X-axis direction and the second axis AX2 is defined in the Y-axis direction.

The first axis AX1 and the second axis AX2 may be perpendicular to each other. That is, the first axis AX1 and the second axis AX2 may be perpendicular to each other in the optical axis OA. Accordingly, the first axis AX1 may be perpendicular to the optical axis OA. Additionally, the second axis AX2 may be perpendicular to the optical axis OA. That is, the optical axis OA, the first axis AX1, and the second axis AX2 may be perpendicular to each other.

A plurality of coordinates may be set on the ninth surface S9 of the fifth lens 150, respectively, on the first axis AX1 and the second axis AX2.

In detail, the ninth surface S9 of the fifth lens 150 may have a first coordinate C1 and a third coordinate C3 set on the first axis AX1. In detail, the ninth surface S9 of the fifth lens 150 may have a first coordinate C1 having a coordinate of (±A,0) and a third coordinate C3 having a coordinate of (±B,0) on the first axis AX1.

In addition, the ninth surface S9 of the fifth lens 150 may have a first Sag value S1 at the first coordinate C1 and a third Sag value S3 at the third coordinate C3.

Additionally, the ninth surface S9 of the fifth lens 150 may have a second coordinate C2 and a fourth coordinate C4 set on the second axis AX2. In detail, the ninth surface S9 of the fifth lens 150 may have a second coordinate C2 having a coordinate of (0, ±A) and a fourth coordinate C4 having a coordinate of (0, ±B) on the second axis AX2.

In addition, the seventh surface S7 of the fifth lens 150 may have a second Sag value S2 at the second coordinate C2 and a fourth Sag value S4 at the fourth coordinate (C4).

At this time, the fifth lens may satisfy the following equations A to I.

$$max \vert Sag\_O \_x \_ 5 \vert \neq max \vert Sag\_O \_y \_ 5 \vert \qquad [ Equation A ]$$

(In Equation A, max |Sag_O_x_5| means the absolute value of the maximum Sag value in the X-axis direction from the object-side surface of the fifth lens, and max |Sag_O_y_5| means the absolute value of the maximum Sag value in the Y-axis direction from the object-side surface of the fifth lens.)

$$1 µm \leq max \vert Sag\_O \_x \_ 5 \vert - max \vert Sag\_O \_y \_ 5 \vert \leq 25 µm or , \\ 3 µm \leq max \vert Sag\_O \_x \_ 5 \vert - max \vert Sag\_O \_y \_ 5 \vert \leq 20 µm or , \\ 5 µm \leq max \vert Sag\_O \_x \_ 5 \vert - max \vert Sag\_O \_y \_ 5 \vert \leq 15 µm \qquad [ Equation B ]$$

$$\vert S 2 - S 1 \vert > \vert S 4 - S 3 \vert \\ \vert A \vert > \vert B \vert \\ \vert S 4 - S 3 \vert \leq 10 µm or \vert S 4 - S 3 \vert \leq 5 µm or \vert S 4 - S 3 \vert \leq 1 µm \qquad [ Equation C ]$$

In Equation C, each formula may be independent, or multiple formulas may be combined with each other.

That is, in the ninth surface S9 of the fifth lens 150, a difference between a Sag value in the first axis and a Sag value in the second axis at coordinates arranged far from the optical axis (0,0) may be greater than a difference between a Sag value in the first axis and a Sag value in the second axis at coordinates arranged close to the optical axis (0,0).

That is, a difference between a Sag value in the first axis and a Sag value in the second axis may increase as the ninth surface S9 of the fifth lens 150 moves away from the optical axis (0,0).

Additionally, the range of a value of |S4−S3| and a value of |S2−S1| may be related to the amount of light passing through the fifth lens and incident on the image sensor unit and the optical characteristics of the optical system.

In detail, when the |S4−S3| is set to a value of 10 μm or less, 5 μm, or 1 μm, the amount of light passing through the fifth lens and incident toward the image sensor unit may be increased. In addition, when the |S2−S1| is set to a value greater than a value of |S4−S3|, that is, when the value of |S2−S1| exceeds 10 μm, 5 μm, or 1 μm, the amount of the light that passes through the fifth lens 150 and incident in the direction of the image sensor unit may be increased. Accordingly, the relative illumination (RI) of the image sensor unit may be increased to 35% or more, and improved optical characteristics may be achieved. That is, the optical system including the fifth lens may have improved MTF characteristics. Additionally, resolution may be improved by increasing the amount of light incident on the image sensor unit.

Here, the relative illumination of the image sensor unit may be defined as a relative ratio of the illuminance in the darkest region to the illuminance in the brightest region among the plurality of regions of the image sensor unit. That is, when the relative illumination is 35% or more, the illuminance in the darkest region of the image sensor unit may mean 35% or more of the illuminance in the brightest region of the image sensor unit.

However, when a value of |S4−S3| is set to a value exceeding 10 μm, the amount of light passing through the fifth lens 150 and incident toward the image sensor unit may decreases, or the MTF characteristics of the entire optical system may be degraded, thereby degrading the optical characteristics.

That is, when the value of |S4−S3| of the fifth lens 150 does not satisfy a value of 10 μm or less, the amount of light incident on the image sensor unit may decrease to reduce resolution, or the overall optical characteristics of the optical system may decrease to increase aberration, and distortion.

On the ninth surface S9 of the fifth lens 150, the absolute values of the Sag value on the first axis and the Sag value on the second axis gradually increase as a distance from the optical axis (0,0) increases. And, the difference between the Sag value on the first axis and the Sag value on the second axis may increase from a specific point.

In addition, the left and right Sag values of the ninth surface S9 of the fifth lens 150 in the first axis AX1 direction and the up and down Sag values in the second axis AX2 direction may be symmetrical to each other.

Accordingly, the fifth surface S5 of the fifth lens 150, whose free-form shape is defined by the Sag values, may be symmetrical in the first axis AX1 direction and symmetrical in the second axis direction AX2. However, rotational symmetry from the first axis AX1 to the second axis AX2 is not satisfied.

Meanwhile, the Sag value of the ninth surface S9 of the fifth lens 150 may be set by equation D below.

$$Z = \frac{{cr}^{3}}{1 + \sqrt{( 1 + k ) {c}^{2} {r}^{2}}} + {\sum }_{i = 1}^{n} {C}_{j} {Z}_{j} \qquad [ Equation D ]$$

(In equation D, Z is the Sag value of the fifth lens, c is the curvature value of the fifth lens, r is the effective diameter value of the fifth lens, k is Conic constant, Cj is the Zernike coefficient at order j, and Zj is the Zernike basis at order j.)

Additionally, the first coordinate C1, the second coordinate C2, the third coordinate C3, and the fourth coordinate C4 may satisfy the following equation E.

$$h 1 = H - t 1 * tan ( θ h - α ) , \vert B \vert < 0.7 * h 1 \leq \vert A \vert \qquad [ Equation E ]$$

(In equation E, h1 is a distance from the optical axis in the negative or positive direction of the first axis, His ½ of the minor axis length of the image sensor unit, t1 is a distance from the ninth surface S9 to the image sensor unit, θh is the chief ray angle at the 0.6 field of the image sensor unit, and a is sin−1 (1/(2*F number)). Here, the field of the image sensor unit may be defined as a relative distance from the center of the image sensor unit to any point of the diagonal length when the center of the image sensor unit is set to 0 field and half of the diagonal length from the center toward the edge of the image sensor unit is set to 1.0 field.)

Meanwhile, when the optical system is applied to a mobile display device such as a smartphone, the average angle of θh may be 34°.

Additionally, the ninth surface S9 of the fifth lens 140 may satisfy Equation F below.

$$\vert S 4 - S 3 \vert = 0 \qquad [ Equation F ]$$

That is, the third Sag value of the third coordinate and the fourth Sag value of the fourth coordinate may be the same. That is, the absolute value of the difference between the third Sag value of the third coordinate and the fourth Sag value of the fourth coordinate that satisfies Equation D may be 0 or more and 10 μm or less.

In detail, the absolute value of the difference between the third Sag value of the third coordinate and the fourth Sag value of the fourth coordinate that satisfies the equation E may be 0 or more and 5 μm or less. In more detail, the absolute value of the difference between the third Sag value of the third coordinate and the fourth Sag value of the fourth coordinate that satisfies the equation E may be 0 or more and 1 μm or less.

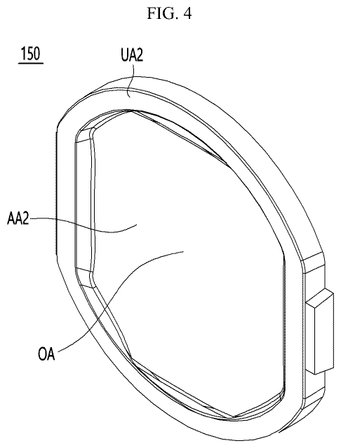

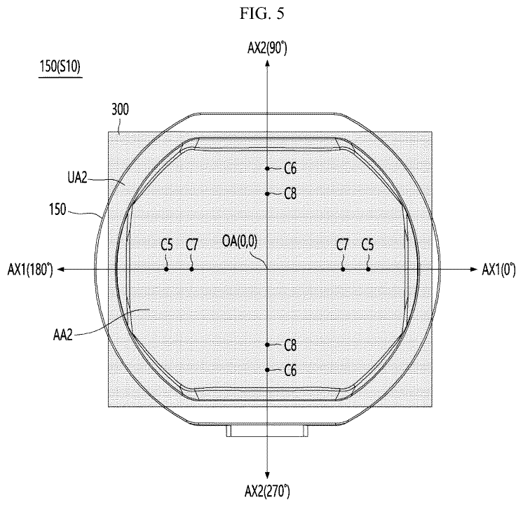

FIGS. 4 and 5 are diagrams for explaining the freeform surface of the tenth surface S10 of the fifth lens 150.

Referring to FIG. 4, the tenth surface S10 of the fifth lens 150 may include a second effective region AA2 and a second ineffective region UA2. In detail, the tenth surface S10 of the fifth lens 150 may include the second effective region AA2, which is a region through which light incident on the fifth lens 150 passes. Light incident on the fifth lens 150 may be refracted in the second effective region AA2 of the tenth surface S10 of the fifth lens 150 to implement optical characteristics.

Additionally, the tenth surface S10 of the fifth lens 150 may include a second ineffective region UA2, which is a region through which light incident on the fifth lens 150 does not pass. Light incident on the fifth lens 150 may not pass through the second ineffective region UA2 of the fifth lens 150. Accordingly, the second ineffective region UA2 of the tenth surface S10 may be unrelated to the optical characteristics of light incident on the fifth lens 150. Additionally, a portion of the second ineffective region UA2 may be fixed to the barrel accommodating the fifth lens 150.

Referring to FIG. 5, a virtual axis for setting the coordinates of the tenth surface S10 of the fifth lens 150 may be set.

In detail, a first axis AX1 and a second axis AX2 may be set on the tenth surface S10 of the fifth lens 150. The first axis AX1 may be defined as a direction parallel to the longitudinal direction of the long axis of the image sensor unit 300. That is, the first axis AX1 may be defined as an axis that passes through the optical axis OA and extends in a direction parallel to the long axis of the image sensor unit 300.

Additionally, the second axis AX2 may be defined as a direction parallel to the minor axis longitudinal direction of the image sensor unit 300. That is, the second axis AX2 may be defined as an axis that passes through the optical axis OA and extends in a direction parallel to the minor axis of the image sensor unit 300.

For example, the first axis AX1 may be defined as the X-axis direction or the Y-axis direction, and may be defined as an axis having angles of 0° and 180° with respect to the optical axis OA. Additionally, the second axis AX2 may be defined as the Y-axis direction or the X-axis direction, and may be defined as an axis having angles of 90° and 270° with respect to the optical axis OA.

The first axis AX1 and the second axis AX2 may be perpendicular to each other. That is, the first axis AX1 and the second axis AX2 may be perpendicular to each other in the optical axis OA. Accordingly, the first axis AX1 may be perpendicular to the optical axis OA. Additionally, the second axis AX2 may be perpendicular to the optical axis OA. That is, the optical axis OA, the first axis AX1, and the second axis AX2 may be perpendicular to each other.

A plurality of coordinates may be set on the tenth surface S10 of the fifth lens 150, respectively, on the first axis AX1 and the second axis AX2.

In detail, the tenth surface S10 of the fifth lens 150 may have a fifth coordinate C5 and a seventh coordinate C7 set on the first axis AX1. In detail, the tenth surface S10 of the fifth lens 150 may set a fifth coordinate C5 having a coordinate of (±C,0) and a seventh coordinate C7 of a coordinate of (±D,0) on the first axis AX1.

In addition, the tenth surface S10 of the fifth lens 150 may have a fifth Sag value S5 at the fifth coordinate C5 and a seventh Sag value S7 at the seventh coordinate C7.

Additionally, the tenth surface S10 of the fifth lens 150 may have a sixth coordinate C6 and an eighth coordinate C8 set on the second axis AX2. In detail, the tenth surface S10 of the fifth lens 150 may set a sixth coordinate C6 having a coordinate of (0, ±C) and an eighth coordinate C8 having a coordinate of (0, ±D) on the second axis AX2.

In addition, the tenth surface S10 of the fifth lens 150 may have a sixth Sag value S6 at the sixth coordinate C6 and an eighth Sag value S8 at the eighth coordinate C8.

At this time, the fifth lens may satisfy the following equation G.

$$\vert S 6 - S 5 \vert > \vert S 8 - S 7 \vert \vert C \vert > \vert D \vert \vert S 8 - S 7 \vert \leq 10 µm or \vert S 8 - S 7 \vert \leq 5 µm \vert S 8 - S 7 \vert \leq 1 µm \qquad [ Equation G ]$$

In the above equation G, each equation may be independent, or multiple equations may be combined with each other.

Additionally, the range of a value of |S8−S7| may be related to the amount of light passing through the fifth lens 150 and incident on the image sensor unit and the optical characteristics of the optical system.

In detail, when |S8−S7| is set to a value of 10 μm or less, 5 μm or less, or 1 μm or less, the amount of light passing through the fifth lens 150 and incident toward the image sensor unit may be increased. Additionally, when the |S8−S7| of the fifth lens 150 is set to a value of 10 μm or less, 5 μm or less, or 1 μm, improved optical characteristics may be achieved. That is, the optical system including the fifth lens 150 may have improved MTF characteristics. In detail, when the |S6−S5| is set to a value greater than a value of |S8−S7|, that is, when the value of |S6−S5| is set to a value of more than 10 μm, more than 5 μm, or more than 1 μm, the amount of light passing through the fifth lens 150 and incident on the image sensor unit may be increased.

Accordingly, the relative illumination (RI) of the image sensor unit may be increased to 35% or more, and improved optical characteristics may be achieved. That is, the optical system including the fourth lens may have improved MTF characteristics. Additionally, resolution may be improved by increasing the amount of light incident on the image sensor unit.

However, when a value of |S8−S7| is set to a value exceeding 10 μm, in detail, the value of |S6−S5| is set greater than the value of |S8−S7|, that is, the value of |S6−S5| is set to a value exceeding 10 μm, the amount of light passing through the fifth lens 150 and incident on the image sensor unit may be reduced, or the MTF characteristics of the entire optical system may be reduced, thereby deteriorating the optical characteristics.

That is, when the value of |S8−S7| of the fifth lens 150 does not satisfy a value of 10 μm or less, in detail, the value of |S6−S5| is set to a value greater than the value of |S8−S7|, that is, when the value of |S6−S5| is set to a value exceeding 10 μm, the amount of light incident on the image sensor unit may decrease, leading to a decrease in resolution, or the overall optical characteristics of the optical system may decrease to increase aberration and distortion.

That is, on the tenth surface S10 of the fifth lens 150, a difference between a Sag value in the first axis and a Sag value in the second axis at coordinates arranged far from the optical axis (0,0) may be greater than a difference between a Sag value in the first axis and a Sag value in the second axis at coordinates arranged close to the optical axis (0,0).

That is, a difference between a Sag value in the first axis and a Sag value in the second axis may increase as a distance from the optical axis (0,0) of the tenth surface S10 of the fifth lens 150 increases.

On the tenth surface S10 of the fifth lens 150, it may be seen that the absolute value of the Sag value in the first axis and the absolute value of the Sag value in the second axis gradually increase as the distance from the optical axis (0,0) increases, and the difference between the Sag value on the first axis and the Sag value on the second axis may increase from a specific point.

In addition, in the tenth surface S10 of the fifth lens 150, the left and right Sag values based on the optical axis in the first axis AX1 direction and up and down Sag values based on the optical axis in the second axis AX2 direction may be symmetrical to each other.

Accordingly, the tenth surface S10 of the fifth lens 150, whose free-form shape is defined by the Sag values, may be symmetrical in the first axis AX1 direction and symmetrical in the second axis direction AX2. However, rotational symmetry from the first axis AX1 to the second axis AX2 is not satisfied.

Meanwhile, the Sag value of the tenth surface S10 of the fifth lens 150 may be set by equation H.

Additionally, the fifth coordinate C5, the sixth coordinate C6, the seventh coordinate C7, and the eighth coordinate C8 may satisfy the following equation H.

$$h 2 = H - t 2 * tan ( θ h - α ) , \vert D \vert < 0.7 * h 1 \leq \vert C \vert \qquad [ Equation H ]$$

(In equation H, h2 is a distance from the optical axis in the negative or positive direction of the first axis, His ½ of the minor axis length of the image sensor unit, t2 is a distance from the tenth surface S10 to the image sensor unit, θh is the chief ray angle at the 0.6 field of the image sensor unit, and α is sin−1 (1/(2*F number)). Here, when half of the diagonal length from the center toward the edge of the image sensor unit is set as a 1.0 field, it may be defined as a relative distance from the center of the image sensor unit to an arbitrary point of the diagonal length.)

Meanwhile, when the optical system is applied to a mobile display device such as a smartphone, the average angle of θh may be 34°.

Additionally, the tenth surface S10 of the fifth lens 150 may satisfy Equation I below.

$$\vert S 8 - S 7 \vert = 0 \qquad [ Equation I ]$$

That is, the seventh Sag value of the seventh coordinate and the eighth Sag value of the eighth coordinate may be the same. That is, the absolute value of the difference between the seventh Sag value of the seventh coordinate and the eighth Sag value of the eighth coordinate that satisfies Equation D may be 0 or more and 10 μm or less.

In detail, the absolute value of the difference between the seventh Sag value of the seventh coordinate and the eighth Sag value of the eighth coordinate that satisfies the equation G may be 0 or more and 5 μm or less. In more detail, the absolute value of the difference between the seventh Sag value of the seventh coordinate and the eighth Sag value of the eighth coordinate that satisfies the equation G may be 0 or more and 3 μm or less.

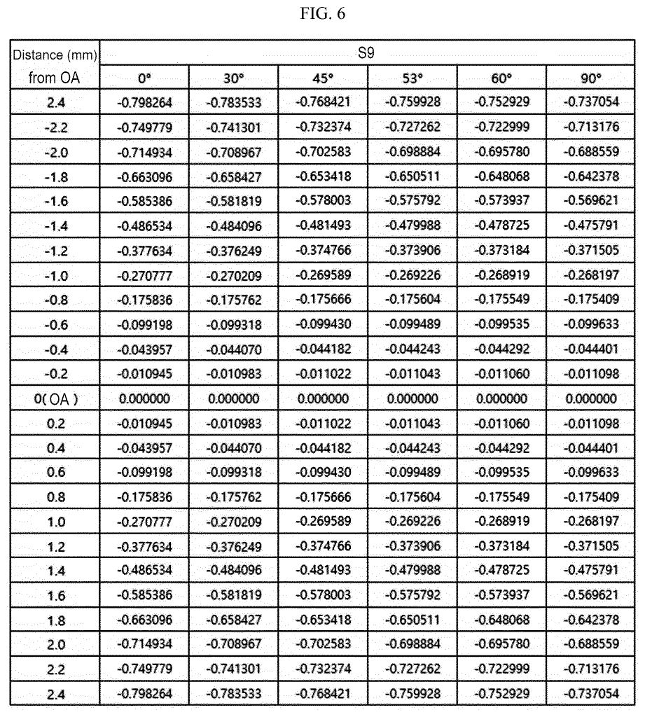

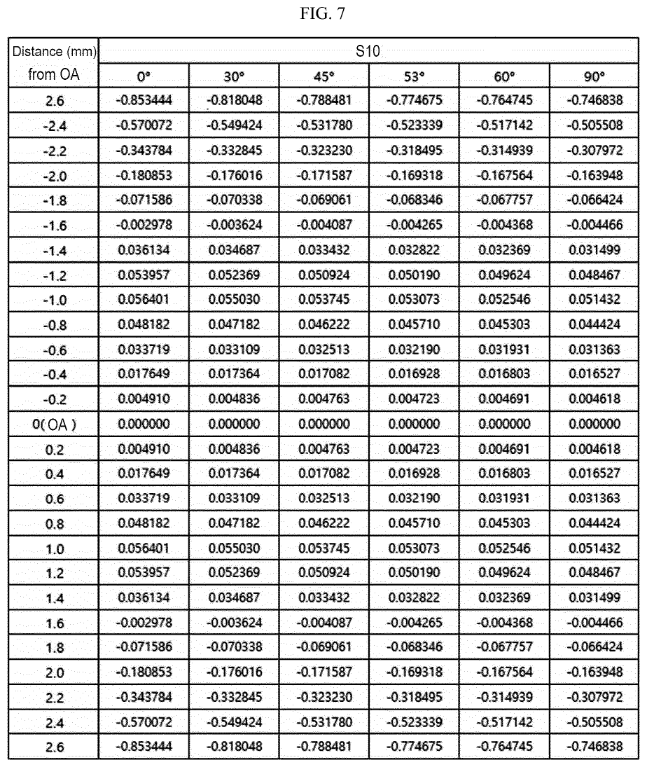

FIGS. 6 and 7 are tables of Sag values at various angles of the ninth and tenth surfaces of the fifth lens having a freeform surface.

In detail, FIGS. 6 and 7 are tables showing Sag values at 0°, 30°, 45°, 53°, 60°, and 90°.

Referring to FIGS. 6 and 7, the ninth and tenth surfaces of the fifth lens may be symmetrical in the first axis direction AX1 and symmetrical in the second axis direction AX2 at all angles. However, the ninth and tenth surfaces of the fifth lens do not satisfy rotational symmetry from the first axis AX1 to the second axis AX2 at all angles.

In the optical system according to the embodiment, the fifth lens 150 may have a relationship between the Sag value and the Sag values set by the equations, and the object-side surface and the sensor-side surface of the fifth lens 150 may have a freeform surface formed by the relationship between the Sag value and the Sag values.

Accordingly, when light passes through the optical system according to the embodiment and is incident on the image sensor unit, the ambient light amount ratio of the image sensor unit may be improved.

That is, the optical system according to the embodiment, light is incident on the image sensor unit through the fifth lens 150, thereby expanding the region where light is incident on the image sensor unit from the optical system, that is, by expanding the effective region of the image sensor unit, the relative illumination of the image sensor unit may be improved.

In detail, the optical system according to the embodiment is configured so that when comparing the illuminance in the brightest and darkest regions of the image sensor unit, light may be incident on the image sensor unit so that the illuminance in the darkest region has an illuminance of 30% or more with respect to the illuminance of the brightest region. In detail, the optical system according to the embodiment is configured so that when comparing the illuminance in the brightest and darkest regions of the image sensor unit, light may be incident on the image sensor unit so that the illuminance in the darkest region has the illuminance of 35% or more with respect to the illuminance in the bright region. More specifically, the optical system according to the embodiment is such that when comparing the illuminance in the brightest region and the darkest region of the image sensor unit, light may be incident on the image sensor unit so that the illuminance in the darkest region has the illuminance of 45% or more with respect to the illuminance in the bright region.

Therefore, the optical system according to the embodiment may increase the amount of light incident on the image sensor unit while maintaining improved optical characteristics without increasing the aperture of the lenses in order to increase the amount of light incident on the image sensor unit.

Additionally, the optical module according to the embodiment may implement miniaturization of the optical system and optical module by using a fifth lens having a freeform surface.

In detail, the optical module according to the embodiment may improve the relative illumination while reducing the size of the optical system and optical module.

When there is no fifth lens including a freeform surface, TTL (distance in the optical axis direction between the first lens and the image sensor unit) of the optical system must be increased in order to improve the relative illumination, but the optical module according to the embodiment may improve the relative illumination without increasing TTL by controlling the direction of light movement using the fifth lens including the freeform surface.

That is, the optical module according to the embodiment may reduce the size of TTL by 10% to 20% compared to the optical module that does not include the fifth lens including a freeform surface. Accordingly, the optical module may be miniaturized, and the optical module may be easily applied to various display devices.

Additionally, the optical module according to the embodiment may have improved MTF and improved resolution by a fifth lens having a freeform surface.

In detail, the optical module according to the embodiment may have improved MTF characteristics by increasing the amount of light incident on the image sensor unit through the fifth lens having the freeform surface.

In addition, the optical module according to the embodiment improves the relative illumination of the light incident on the image sensor unit, thereby preventing a decrease in resolution due to post-correction after image acquisition.

In other words, an optical module that does not include a lens with a freeform surface has a low relative illumination of the image sensor unit, and a post-correction process is required to obtain an image through the image sensor unit and the resolution of the optical module may be lowered during the post-correction process.

However, the optical module according to the embodiment increases the relative illumination of the image sensor unit by using a lens having a freeform surface, and as a result, post-correction is not required or resolution is not significantly reduced due to the post-correction process, so it may have improved resolution.

Meanwhile, the third lens 130 and the fourth lens 140, which are disposed adjacent to the fifth lens 140, which is a freeform lens, may have the peripheral shape of the lens curved toward the object side. In detail, the third lens 130 and the fourth lens 140 may be formed in a shape that bends in the direction of the object side as it goes from the optical axis to the end of the effective diameter of the lens.

The shapes of the third lens 140 and the fourth lens 140 may be defined by changes in the slope angle of the lenses. In addition, the thickness and spacing of the third lens 130 and the fourth lens 140 at each position may be defined by changes in the slope angles of the third lens 130 and the fourth lens 140.

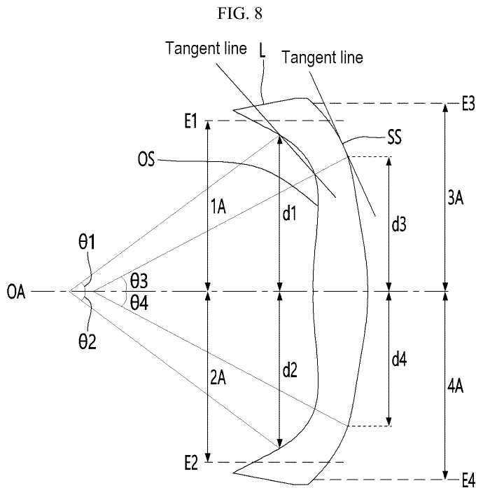

FIG. 8 is a diagram for explaining the slope angle of a lens of an optical module according to an embodiment. The definition of the slope angle of the lens described in FIG. 8 may be equally applied to the first to fifth lenses.

Referring to FIG. 8, the lens L may have a normal line defined that passes through an arbitrary point on the object-side surface OS of the lens. In detail, on the object-side surface OS of the lens, a normal line extending in a direction perpendicular to a tangent line passing through an arbitrary point of the object-side surface OS and passing through the arbitrary point may be defined.

Accordingly, the object-side surface OS of the lens may have a slope angle defined as the angle between the normal line passing through the arbitrary point of the object-side surface OS and the internal angle formed by the optical axis.

The slope angle may be expressed as positive (+) or negative (−) depending on the position at which the internal angle is formed. In detail, when the internal angle is formed toward the sensor side based on the object-side surface OS of the lens, the slope angle may be positive (+). Additionally, when the internal angle is formed in the direction of the object side based on the object-side surface OS, the slope angle may be negative (−). That is, the increase or decrease in the slope angle of the lens L may be determined based on the absolute value of the slope angle. That is, the description of the size of the slope angle described below is based on the size of the absolute value of the slope angle, which is the absolute value of the internal angle.

The lens L may have a first end E1 and a second end E2 defining an effective region of the object-side surface OS of the lens. In detail, the object-side surface OS of the lens may be defined as a first end E1 and a second end E2 in the X-axis or Y-axis direction with respect to the optical axis.

At this time, the size of the slope angle of the object-side surface OS of the lens may change according to positions in the first region 1A from the optical axis OA to the first end E1 and the second region 2A from the optical axis OA to the second end E2. The first region 1A and the second region 2A may each be defined as an effective radius that is half of the effective diameter (effective region) of the object-side surface OS of the lens.

The object-side surface OS of the lens may be defined by a first slope angle θ1 on the first region 1A and a second slope angle θ2 on the second region 2A.

The first slope angle θ1 and the second slope angle θ2 may have a positive (+) or negative (−) value depending on the position of the internal angle.

Likewise, a slope angle may be defined on the sensor-side surface SS of the lens. In detail, the lens L may have a normal line defined that passes through an arbitrary point on the sensor-side surface SS of the lens. In detail, on the sensor-side surface SS of the lens, a normal line extending in a direction perpendicular to a tangent line passing through an arbitrary point of the sensor-side surface SS and passing through an arbitrary point may be defined.

Accordingly, the sensor-side surface SS of the lens may have a slope angle defined as the angle between the normal line passing through an arbitrary point of the sensor-side surface SS and the internal angle formed by the optical axis.

At this time, the size of the slope angle of the sensor-side surface SS of the lens may change according to positions in the third region 3A from the optical axis OA to the third end E3 and the fourth region 4A from the optical axis OA to the fourth end E4. The third region 3A and the fourth region 4A may each be defined as an effective radius that is half of the effective diameter (effective region) of the sensor-side surface SS of the lens.

The sensor-side surface SS of the lens may be defined by a third slope angle θ3 in the third region 3A and a fourth slope angle θ4 in the fourth region 4A.

The third slope angle θ3 and the fourth slope angle θ4 may have positive (+) or negative (−) values depending on the position of the inner angle.

The size of the slope angle of the third lens 130 and the fourth lens 140 may change as it moves from the optical axis of the lens toward the end of the effective diameter. In detail, the optical module according to the embodiment may improve optical properties of the optical module by setting an internal angle for each position of the third lens 130 and the fourth lens 140 disposed adjacent to the fifth lens 150 which is a freeform lens and a thickness and interval for each position set by the slope angle within a set range.

First, the third lens 130 will be described.

The size of the slope angle of the fifth surface S5 of the third lens 130 may vary depending on the position of the fifth surface S5. In detail, the size of the slope angle of the fifth surface S5 may vary depending on the position within the effective region of the fifth surface S5. In more detail, the size of the slope angle of the fifth surface S5 may be changed for each position of the seventh surface S7 while extending from the optical axis in the X-axis or Y-axis direction of the fifth surface S5 perpendicular to the optical axis.

In detail, the first slope angle θ1 and the second slope angle θ2 of the fifth surface S5 may change in the first region 1A and the second region 2A. In detail, the first slope angle θ1 may increase in the first region 1A, and the second slope angle θ2 may increase in the second region 2A.

That is, on the fifth surface S5, the absolute value of the first slope angle θ1 may gradually increase while extending from the optical axis toward the first end E1, and the absolute value of the second slope angle θ2 may gradually increase while extending from the optical axis toward the second end E2.

Accordingly, the fifth surface S5 may be formed in a shape whose curvature gradually increases while extending from the optical axis toward the first end E1 and the second end E2. That is, the fifth surface S5 may be formed in a shape that is curved in the direction toward the object, and may be formed so that the curvature increases as it extends from the optical axis toward the first end E1 and the second end E2.

In addition, the change amount of the first slope angle θ1 and the second slope angle θ2 of the fifth surface S5 may gradually increase while extending from the optical axis toward the first end E1 and the second end E2.

In detail, when the total distance from the optical axis to the first end E1 is defined as 1, in the first region of the fifth surface S5, the change amount of the first slope angle θ1 in the first region from the optical axis to 0.5 in the direction of the first end E1 may be smaller than the change amount of the slope angle in the first region from greater than 0.5 to 1.

In addition, in the second region of the fifth surface S5, the change amount in the second slope angle θ2 in the second region from the optical axis to 0.5 in the direction of the second end E2 may be smaller than the change amount of the sloe angle in the second region from greater than 0.5 to 1.

That is, the change amount in the first slope angle θ1 and the second slope angle θ2 of greater than 50% to 100% of the effective radius of the fifth surface S5 on the optical axis may be greater than the change amount in the first slope angle θ1 and the second slope angle θ2 of 50% or less of the effective radius.

Accordingly, the seventh surface S7 may be formed in a shape having a small curvature and a small change amount in curvature in the first and second regions from the optical axis to 50% of the effective diameter, and may have a large curvature and a large change amount in curvature while extending from greater than 50% to the end of the effective diameter.

Additionally, the size of the slope angle of the sixth surface S6 of the third lens 130 may vary depending on the position of the sixth surface S6. In detail, the size of the slope angle of the sixth surface S6 may vary depending on the position within the effective region of the sixth surface S6. In more detail, the size of the slope angle of the sixth surface S6 may be changed for each position of the six surface S6 while extending from the optical axis in the X-axis or Y-axis direction of the sixth surface S6 perpendicular to the optical axis.

In detail, the third slope angle θ3 and the fourth slope angle θ4 of the sixth surface S6 may change in the third region 3A and the fourth region 4A. In detail, the third slope angle θ3 may increase in the third region 3A, and the fourth slope angle θ4 may increase in the fourth region 4A.

That is, on the sixth surface S6, the absolute value of the third slope angle θ3 may gradually increase while extending from the optical axis toward the third end E3, and the absolute value of the fourth slope angle θ4 may gradually increase while extending from the optical axis to the fourth end E4.

Accordingly, the sixth surface S6 may be formed in a shape whose curvature gradually increases while extending from the optical axis toward the third end E3 and the fourth end E4. That is, the sixth surface S6 is formed in a shape that is curved in the direction toward the object, and may be formed so that the curvature increases at it extends from the optical axis toward the third end E3 and the fourth end E4.

In addition, the change amount of the third slope angle θ3 and the fourth slope angle θ4 of the sixth surface S6 may gradually increase while extending from the optical axis toward the third end E3 and the fourth end E4.

In detail, in the third region of the sixth surface S6, the change amount in the third slope angle θ3 from the optical axis to 0.5 in the direction of the third end E3 may be smaller than the change amount of the slope angle in the third region from frater than 0.5 to 1.

In addition, in the fourth region of the sixth surface S6, the change amount in the fourth slope angle θ4 from the optical axis to 0.5 in the direction of the fourth end E4 may be smaller than the change amount of the slope angle in the fourth region from greater than 0.5 to 1.

That is, the change amount in the third slope angle θ3 and the fourth slope angle θ4 of more than 50% to 100% of the effective radius of the sixth surface S6 on the optical axis may be greater than the change amount in the third slope angle θ3 and the fourth slope angle θ4 of 50% or less of the effective radius.

Accordingly, the sixth surface S6 may be formed in a shape having a small curvature and a small change amount in curvature in the third and fourth regions from the optical axis to 50% of the effective diameter, and may have a large curvature and a large change amount in curvature while extending from more than 50% to the end of the effective diameter.

Additionally, the third lens 130 may have different slope angles on the fifth surface S5 and the sixth surface S6.

For example, the maximum of the absolute value of the slope angle of the fifth surface S5 of the third lens 130 may be different from the maximum of the absolute value of the slope angle of the sixth surface S6. In detail, the maximum absolute value of the slope angle of the fifth surface S5 may be smaller than the maximum absolute value of the slope angle of the sixth surface S6.

In addition, the third lens 130 may have a difference between the maximum and a non-zero minimum of the absolute value of the slope angle of the fifth surface S5 and a maximum and a non-zero minimum of the absolute value of the slope angle of the sixth surface S6. Specifically, the difference between the maximum and the non-zero minimum of the absolute value of the slope angle of the fifth surface S5 may be smaller than the difference between the maximum and the non-zero minimum of the absolute value of the slope angle of the sixth surface S6.

Additionally, the thickness of the third lens 130 may change while extending from the optical axis in the direction of the effective diameter. In detail, the thickness of the third lens 130 may change while extending from the optical axis toward the first end E1 or the second end E2, which is the effective region of the fifth surface S5.

For example, the thickness of the third lens 130 may increase while extending from the optical axis toward the first end E1, which is the effective region of the fifth surface S5. Additionally, the thickness of the third lens 130 may increase as it extends from the optical axis toward the second end E2, which is the effective region of the fifth surface S5.

The maximum thickness of the third lens 130 may be the end of the effective region of the third lens 130. Additionally, the minimum thickness of the third lens 130 may be within the effective region of the third lens 130. For example, the minimum thickness of the third lens 130 may be the thickness of the third lens 130 at the optical axis.

Additionally, the Sag value of the third lens 130 may change as it extends from the optical axis in the direction of the effective diameter.

The size of the Sag value of the fifth surface S5 of the third lens 130 may vary depending on the position of the fifth surface S5. In detail, the size of the Sag value of the fifth surface S5 may vary depending on the position within the effective region of the fifth surface S5. In more detail, the size of the Sag value of the fifth surface S5 may be changed for each position of the fifth surface S5 while extending from the optical axis in the X-axis or Y-axis direction of the fifth surface S5 perpendicular to the optical axis.

In detail, the Sag value of the fifth surface S5 may change in the first region 1A and the second region 2A. In detail, the Sag value may increase in the first region 1A and may increase in the second region 2A.

That is, the absolute value of the Sag value may gradually increase as the fifth surface S5 extends from the optical axis to the first end E1, and the absolute value of the Sag value may gradually increase as the optical axis extends from the second end E2.

In addition, the change amount of the Sag value of the fifth surface S5 may gradually increase while extending in the direction of the first end E1 and the second end E2 on the optical axis.

In detail, in the first region of the fifth surface S5, a change amount of a Sag value in the first region from the optical axis to 0.5 in the direction of the first end E1 may be smaller than a change amount of a Sag value in the first region from more than 0.5 to 1.

In addition, in the second area of the fifth surface S5, the change amount of the Sag value in the second area from the optical axis to 0.5 in the direction of the second end E2 may be smaller than the change amount of the Sag value in the second area from more than 0.5 to 1.

That is, the change amount of the sag value greater than 50% to 100% of the effective radius of the fifth surface S5 on the optical axis may be greater than the change amount of the sag value equal to or less than 50%.

Additionally, the size of the Sag value of the sixth surface S6 of the third lens 140 may change depending on the position of the sixth surface S6. In detail, the size of the Sag value of the sixth surface S6 may change depending on the position within the effective region of the sixth surface S6. In more detail, the size of the Sag value of the sixth surface S6 may be changed for each position of the sixth surface S6 while extending from the optical axis in the X-axis or Y-axis direction of the sixth surface S6 perpendicular to the optical axis.

In detail, the Sag value of the sixth surface S6 may change in the third region 3A and the fourth region 4A. In detail, the Sag value may increase in the third region 3A and the fourth region 34.

That is, the absolute value of the Sag value may gradually increase as the sixth surface S6 extends from the optical axis toward the third end E3 and the fourth end E4.

Additionally, the change amount of the Sag value of the sixth surface S6 may gradually increase as it extends from the optical axis toward the third end E3 and the fourth end E4.

In detail, in the third region and the fourth region of the sixth surface S6, the change amount of the sag values in the third region and the fourth region from the optical axis to 0.5 in the direction of the third end E3 and the fourth end E4 may be smaller than the change amount of the third region and the fourth region from more than 0.5 to 1.

That is, the change amount of the Sag value exceeding 50% to 100% of the effective radius of the sixth surface S6 on the optical axis may be greater than the change amount of the Sag value less than 50%.

Hereinafter, the fourth lens 140 will be described.

The size of the slope angle of the seventh surface S7 of the fourth lens 140 may vary depending on the position of the seventh surface S7. In detail, the size of the slope angle of the seventh surface S7 may vary depending on the position within the effective region of the seventh surface S7. In more detail, the size of the inclination angle of the seventh surface S7 may be changed for each position of the seventh surface S7 while extending from the optical axis in the X-axis or Y-axis direction of the seventh surface S7 perpendicular to the optical axis.

In detail, the first slope angle θ1 and the second slope angle θ2 of the seventh surface S7 may change in the first region 1A and the second region 2A. In detail, the first slope angle θ1 may increase in the first region 1A, and the second slope angle θ2 may increase in the second region 2A.

In detail, the first slope angle θ1 may increase in the first region 1A, and the second slope angle θ2 may increase in the second region 2A.

That is, on the seventh surface S7, the absolute value of the first slope angle θ1 may gradually increase while extending from the optical axis to the first end E1, and the absolute value of the second slope angle θ2 may gradually increase while extending from the optical axis to the second end E2.

Accordingly, the seventh surface S7 may be formed in a shape whose curvature gradually increases while extending from the optical axis toward the first end E1 and the second end E2. That is, the seventh surface S7 may be formed in a shape that is curved in the direction toward the object, and may be formed to increase a curvature while extending from the optical axis in the directions of the first end E1 and the second end E2.

Additionally, the size of the slope angle of the eighth surface S8 of the fourth lens 150 may change depending on the position of the eighth surface S8. In detail, the size of the slope angle of the eighth surface S8 may vary depending on the position within the effective region of the eighth surface S8. In more detail, the size of the inclination angle of the eighth surface S8 may be changed for each position of the eighth surface S8 while extending from the optical axis in the X-axis or Y-axis direction of the eighth surface S8 perpendicular to the optical axis.

In detail, the third slope angle θ3 and the fourth slope angle θ4 of the eighth surface S8 may change in the third region 3A and the fourth region 4A. In detail, the third slope angle θ3 may increase or decrease in the third region 3A, and the fourth slope angle θ4 may increase or decrease in the fourth region 4A. In more detail, the third slope angle θ3 may increase, decrease, and then increase again in the third region 3A. Additionally, the fourth slope angle θ4 may increase, decrease, and then increase again in the fourth region 4A.

That is, the absolute value of the third slope angle θ3 may gradually increase, decrease, and then increase again as the eighth surface S8 extends from the optical axis in the direction of the third end E3, and the absolute value of the fourth inclination angle θ4 may gradually increase, then decrease, and then increase again as the eight surface S8 extend in the direction of the fourth end E4 from the optical axis.

Accordingly, the eighth surface S8 may be formed in a shape in which the curvature gradually increases and then decreases and then increases again while extending from the optical axis to the third end E3 and the fourth end E4. That is, the eighth surface S8 may be formed in a shape that is curved toward the object, and the curvature may increase and then decrease and then increase again while extending from the optical axis to the third end E3 and the fourth end E4.

For example, when the total distance from the optical axis to the third end E3 and the fourth end E4 is defined as 1, in the third and fourth regions of the eighth surface S8, a third slope angle θ3 and a fourth slope angle θ4 may increase in the third and fourth regions from 0.1 to 0.75 in the direction of the third and fourth ends E1 and E4 from the optical axis. That is, the third slope angle θ3 and the fourth slope angle θ4 in the third and fourth regions from the optical axis to a distance of 10% to 75% of the effective radius of the eighth surface S8 may increase.

In addition, in the third region and the fourth region of the eighth surface S8, a third slope angle θ3 and a fourth slope angle θ4 in the third region and the fourth region from the optical axis to greater than 0.75 to 0.85 in the direction of the third end E3 and the fourth end E4 may decrease. That is, the third slope angle θ3 and the fourth slope angle θ4 in the third region and the fourth region from the optical axis to a distance greater than 75% to 85% of the effective radius of the eighth surface S8 may decrease.

In addition, in the third and fourth regions of the eighth surface S8, a third slope angle θ3 and a fourth slope angle θ4 in the third and fourth regions from greater than 0.85 to 0.95 in a direction from the optical axis to the third and fourth ends E3 and E4 may increase. That is, the third slope angle θ3 and the fourth slope angle θ4 in the third and fourth regions from the optical axis to a distance greater than 85% to 95% of the effective radius of the tenth surface S10 may increase.

Additionally, the fourth lens 140 may have different slope angles on the seventh surface S7 and the eighth surface S8.

For example, the fourth lens 140 may have a different maximum absolute value of the slope angle of the seventh surface S7 and a maximum absolute value of the slope angle of the eighth surface S8. In detail, the maximum absolute value of the slope angle of the seventh surface S7 may be greater than the maximum absolute value of the slope angle of the eighth surface S8.

In addition, in the fourth lens 140, a difference between a maximum and a non-zero minimum of the absolute value of the inclination angle of the seventh surface S7 and a difference between a maximum and a non-zero minimum of the inclination angle of the eighth surface S8 may be different. Specifically, the difference between the maximum and the non-zero minimum of the absolute value of the inclination angle of the seventh surface S7 may be greater than the difference between the maximum and the non-zero minimum of the absolute value of the inclination angle of the eighth surface S8.

Additionally, the thickness of the fourth lens 140 may change while extending from the optical axis in the direction of the effective diameter. In detail, the thickness of the fourth lens 140 may change while extending from the optical axis toward the first end E1 or the second end E2, which is the effective region of the seventh surface S7.

For example, the thickness of the fourth lens 140 may increase and decrease while extending from the optical axis in the directions of first and second ends E1 and E2, which are effective regions of the seventh surface S7. Specifically, the thickness of the fourth lens 140 may increase or decrease while extending from the optical axis in the directions of first and second ends E1 and E2, which are effective regions of the seventh surface S7. More specifically, the thickness of the fourth lens 140 may increase and decrease while extending from the optical axis in the directions of first and second ends E1 and E2, which are effective regions of the seventh surface S7.

For example, the thickness of the fourth lens 140 may increase from more than 0.1 to 0.75 in the direction from the optical axis to the first end E1 and the second end E2.

Additionally, the thickness of the fourth lens 140 may decrease from more than 0.75 to 0.95 in the direction from the optical axis to the first end E1 and the second end E2.

The maximum thickness of the fourth lens 140 may be located within the effective region of the fourth lens 140. For example, the maximum thickness of the fourth lens 150 may be the thickness of the fourth lens 140 at the optical axis.

Additionally, the minimum thickness of the fourth lens 140 may be located within the effective region of the fourth lens 140. For example, the minimum thickness of the fourth lens 140 may be in the range of 0.40 to 0.60 from the optical axis toward the first end E1 and the second end E2.

Additionally, the Sag value of the fourth lens 140 may change as it extends from the optical axis in the direction of the effective diameter.

The size of the Sag value of the seventh surface S7 of the fourth lens 140 may change depending on the position of the seventh surface S7. In detail, the size of the Sag value of the seventh surface S7 may change depending on the position within the effective region of the seventh surface S7. In more detail, the size of the Sag value of the seventh surface S7 may be changed for each position of the seventh surface S7 while extending from the optical axis in the X-axis or Y-axis direction of the seventh surface S7 perpendicular to the optical axis.

In detail, the Sag value of the seventh surface S7 may change in the first region 1A and the second region 2A. In detail, the Sag value may increase in the first region 1A and may increase in the second region 1A.

That is, the seventh surface S7 may increase an absolute value of a Sag value while extending from the optical axis to the first end E1, and may increase an absolute value of a Sag value while extending from the optical axis to the second end E2.

Additionally, the size of the Sag value of the eighth surface S8 of the fourth lens 140 may change depending on the position of the eighth surface S8. In detail, the size of the Sag value of the eighth surface S8 may change depending on the position within the effective region of the eighth surface S8. In more detail, the size of the Sag value of the eighth surface S8 may be changed for each position of the eighth surface S8 while extending from the optical axis in the X-axis or Y-axis direction of the eighth surface S8 perpendicular to the optical axis.

In detail, the Sag value of the eighth surface S8 may change in the third region 3A and the fourth region 4A. In detail, the Sag value may increase in the third region 3A and the fourth region 34.

That is, the absolute value of the Sag value may gradually increase as the eighth surface S8 extends from the optical axis toward the third end E3 and the fourth end E4.

Additionally, the change amount of the Sag value of the eighth surface S8 may gradually increase as it extends from the optical axis toward the third end E3 and the fourth end E4.

In detail, in the third region and the fourth region of the eighth surface S8, the change amount of the sag value in the third region and the fourth region from the optical axis to 0.5 in the direction of the third end E3 and the fourth end E4 may be smaller than the amount of change in the sag value in the third region from more than 0.5 to 1.

That is, the change amount of the Sag value exceeding 50% to 100% of the effective radius of the eighth surface S8 on the optical axis may be greater than the change amount of the Sag value less than 50%.

The optical system and optical module according to the embodiment may satisfy at least one of the equations described below. Accordingly, the optical system and optical module according to the embodiment may improve aberration characteristics and have improved optical characteristics.

The optical system and optical module according to the embodiment may satisfy Equation 1 below.

$$60 ° \leq FOV ( θ ) \leq 90 ° \qquad [ Equation 1 ]$$

(In Equation 1, FOV means the effective viewing angle of the optical system.)

The optical system and optical module according to the embodiment may satisfy Equation 2 including any one of Equation 2-1, Equation 2-2, and Equation 2-3 below.

$$0.4 \leq TTL / ImgH \leq 4. \qquad [ Equation 2 ‐ 1 ]$$

$$0.5 \leq TTL / ImgH \leq 1. \qquad [ Equation 2 ‐ 2 ]$$

$$0.6 \leq TTL / ImgH \leq 0.75 \qquad [ Equation 2 ‐ 3 ]$$

(In Equation 2, TTL (Total track length) means a distance in the optical axis direction from the vertex of the object-side surface of the first lens to an image surface of the image sensor unit, and ImgH means twice a diagonal distance from the image surface of the image sensor unit overlapping the optical axis to the 1.0 field region of the image sensor unit.)

The optical system and optical module according to the embodiment may have a small TTL size by satisfying Equation 2 above. Accordingly, miniaturization of the optical system and optical module according to the embodiment may be implemented, and the optical system and the optical module according to the embodiment may be easily applied to display devices such as smartphones.

The optical system and optical module according to the embodiment may satisfy Equation 3 below.

$$CA\_O \_x < CA\_O \_ 5 \qquad [ Equation 3 ]$$

(In Equation 3, CA_O_x means an effective diameter of the object-side surface of the lens closest to the aperture stop, and CA_O_5 means to the effective diameter of the object-side surface of the fifth lens.)

As the optical system and optical module according to the embodiment satisfies Equation 3 above, the fifth lens with a large effective diameter and sensitive optical characteristics may be placed away from the aperture stop to improve the sensitivity reduction characteristics of the optical system and optical module.

The optical system and optical module according to the embodiment may satisfy Equation 4 including any one of Equation 4-1, Equation 4-2, and Equation 4-3 below.

$$5 ° < \vert SA 1 \_O \_ 3 \vert \leq 60 ° \\ 10 ° < \vert SA 1 \_S \_ 3 \vert \leq 70 ° \qquad [ Equation 4 ‐ 1 ]$$

$$10 ° < \vert SA 1 \_O \_ 3 \vert \leq 50 ° \\ 15 ° < \vert SA 1 \_S \_ 3 \vert \leq 60 ° \qquad [ Equation 4 ‐ 2 ]$$

$$15 ° < \vert SA 1 \_O \_ 3 \vert \leq 40 ° \\ 20 ° < \vert SA 1 \_S \_ 3 \vert \leq 50 ° \qquad [ Equation 4 ‐ 3 ]$$

(In Equation 4, SA1_O_3 means the slope angle between the normal line of the object-side surface and the optical axis at any point on the object-side surface at a distance in the range of 75% to 95% of the distance from the optical axis of the third lens to the effective diameter, and SA1_S_3 means the slope angle between the normal line of the sensor-side surface and the optical axis at any point on the sensor-side surface at a distance ranging from 75% to 95% of the distance from the optical axis of the third lens to the effective diameter.)

As the optical system and optical module according to the embodiment satisfy the above equation 4, a curvature of the lens surface may be increased in a portion far from the optical axis of the third lens disposed adjacent to the fifth lens, which is a freeform lens, that is, in a region adjacent to an end direction of the effective diameter of the third lens. Accordingly, aberration characteristics of the optical system and the optical module may be improved.

The optical system and optical module according to the embodiment may satisfy Equation 5 including any one of Equation 5-1, Equation 5-2, and Equation 5-3 below.

$$10 ° < \vert SA 1 \_O \_ 4 \vert \leq 70 ° 5 ° < \vert SA 1 \_S \_ 4 \vert \leq 60 ° \qquad [ Equation 5 ‐ 1 ]$$

$$15 ° < \vert SA 1 \_O \_ 4 \vert \leq 60 ° 10 ° < \vert SA 1 \_S \_ 4 \vert \leq 50 ° \qquad [ Equation 5 ‐ 2 ]$$

$$20 ° < \vert SA 1 \_O \_ 4 \vert \leq 50 ° 15 ° < \vert SA 1 \_S \_ 4 \vert \leq 40 ° \qquad [ Equation 5 ‐ 3 ]$$

(In Equation 5, SA1_O_4 means the slope angle between the normal line of the object-side surface and the optical axis at any point on the object-side surface at a distance in the range of 75% to 95% of the distance from the optical axis of the fourth lens to the effective diameter, and SA1_S_4 means the slope angle between the normal line of the sensor-side surface and the optical axis at any point on the sensor-side surface at a distance ranging from 75% to 95% of the distance from the optical axis of the fourth lens to the effective diameter.)

As the optical system and optical module according to the embodiment satisfy Equation 5 above, the curvature of the fourth lens disposed closest to the image sensor unit and adjacent to the fifth lens, which is a freeform lens, may be increased within a set region range. Accordingly, the aberration characteristics of the optical system and optical module may be improved.

The optical system and optical module according to the embodiment may satisfy Equation 6 including any one of Equation 6-1, Equation 6-2, and Equation 6-3 below.

$$5 ° \leq \vert SA 1 \_O \_x \_ 5 \vert \leq 60 ° , 5 ° \leq \vert SA 1 \_O \_y \_ 5 \vert \leq 60 ° \qquad [ Equation 6 ‐ 1 ]$$

$$10 ° \leq \vert SA 1 \_O \_x \_ 5 \vert \leq 40 ° , 10 ° \leq \vert SA 1 \_O \_y \_ 5 \vert \leq 40 ° \qquad [ Equation 6 ‐ 2 ]$$

$$15 ° \leq \vert SA 1 \_O \_x \_ 5 \vert \leq 30 ° , 15 ° \leq \vert SA 1 \_O \_y \_ 5 \vert \leq 30 ° \qquad [ Equation 6 ‐ 3 ]$$

(In Equation 6, SA1_O_x_5 means a slope angle between the normal line and the optical axis at any point on the object-side surface at a distance in the range of 75% to 95% of the distance from the optical axis to the effective diameter in the X-axis direction from the optical axis of the fifth lens, and SA1_O_y_5 means an angle between the normal line and the optical axis at any point on the object-side surface at a distance in the range of 75% to 95% of the distance from the optical axis to the effective diameter in the Y-axis direction from the optical axis of the fifth lens.)

As the optical system and optical module according to the embodiment satisfy Equation 6 above, the curvature of the fifth lens, which is a freeform lens, may be formed within a set range in a set region. Accordingly, the aberration characteristics of the optical system and optical module may be improved, and the image quality in the peripheral region may be improved.

The optical system and optical module according to the embodiment may satisfy Equation 7 including any one of Equation 7-1, Equation 7-2, and Equation 7-3 below.

$$10 ° \leq \vert SA 1 \_S \_x \_ 5 \vert \leq 80 ° , 5 ° \leq \vert SA 1 \_S \_y \_ 5 \vert \leq 70 ° \qquad [ Equation 7 ‐ 1 ]$$

$$15 ° \leq \vert SA 1 \_S \_x \_ 5 \vert \leq 70 ° , 10 ° \leq \vert SA 1 \_S \_y \_ 5 \vert \leq 60 ° \qquad [ Equation 7 ‐ 2 ]$$

$$20 ° \leq \vert SA 1 \_S \_x \_ 5 \vert \leq 60 ° , 15 ° \leq \vert {SA1}_{-} S\_y \_ 5 \vert \leq 50 ° \qquad [ Equation 7 ‐ 3 ]$$

(In Equation 7, SA1_S_x_5 means the slope angle between the normal line and the optical axis at any point on the sensor-side surface of a range of the 75% to 95% between the optical axis and the effective diameter in the X-axis direction of the fifth lens, and SA1_S_y_5 means the slope angle between the normal line and the optical axis at any point on the sensor-side surface of a range of the 75% to 95% between the optical axis and the effective diameter in the Y-axis direction of the fifth lens.)

As the optical system and optical module according to the embodiment satisfy Equation 7 above, the curvature of the fifth lens, which is a freeform lens, may be formed within a set range in a set region. Accordingly, the aberration characteristics of the optical system and optical module may be improved, and the image quality in the peripheral region may be improved.

The optical system and optical module according to the embodiment may satisfy Equation 8 including any one of Equation 8-1, Equation 8-2, and Equation 8-3 below.

$$0.1 \leq CD\_ ( 4 / 5 ) / max D\_ ( 4 / 5 ) \leq 1.5 \qquad [ Equation 8 ‐ 1 ]$$

$$0.2 \leq CD\_ ( 4 / 5 ) / max D\_ ( 4 / 5 ) \leq 1.3 \qquad [ Equation 8 ‐ 2 ]$$

$$0.3 \leq CD\_ ( 4 / 5 ) / max D\_ ( 4 / 5 ) \leq 1. \qquad [ Equation 8 ‐ 3 ]$$

(In Equation 9, CD_(4/5) means a distance from the optical axis of the fourth lens and the fifth lens, and max D_(4/5) means a maximum distance between the fourth lens and the fifth lens.)

As the optical system and optical module according to the embodiment satisfy Equation 8, the distance on the optical axis between the fourth lens and the fifth lens may be smaller than the maximum distance. Accordingly, the fourth lens and the fifth lens may be formed in a shape that increases as the distance between the fourth lens and the fifth lens increases from the optical axis. Accordingly, aberrations of the optical system and optical module may be reduced, and image quality in the peripheral region may be improved.

The optical system and optical module according to the embodiment may satisfy Equation 9 below.

$$CA\_O \_x < CA\_O \_x + 1 < CA\_O \_x + 2 … < CA\_O \_ 5 \qquad [ Equation 9 ]$$

(In Equation 9, CA_O_x means an effective diameter of the object-side surface of the lens closest to the aperture stop, and CA_O_5 means an effective diameter of the object-side surface of the fifth lens.)

As the optical system and optical module according to the embodiment satisfy the above Equation 9, since lenses having a large effective diameter and sensitive optical properties are arranged far from the aperture stop, aberration characteristics of the optical system and the optical module may be improved, and miniaturization of the optical module may be implemented by reducing TTL.

The optical system and optical module according to the embodiment may satisfy Equation 10 below.

$$min \vert Sag\_O \_x \_ 5 \vert \neq min \vert Sag\_O \_y \_ 5 \vert \qquad [ Equation 10 ]$$

As the optical system and optical module according to the embodiment satisfy Equation 10 above, the minimum absolute value of the Sag value in the X-axis direction and the minimum absolute value of the Sag value in the Y-axis direction of the fifth lens, which is a freeform lens, may be done differently. Accordingly, the relative illumination of the optical system and optical module may be improved, thereby improving the image quality in the peripheral region.

The optical system and optical module according to the embodiment may satisfy Equation 11 below.

$$max \vert Sag\_O \_x \_ 5 \vert - min \vert Sag\_O \_x \_ 5 \vert \neq max \vert Sag\_O \_y \_ 5 \vert - min \vert Sag\_O \_y \_ 5 \vert \qquad [ Equation 11 ]$$

(In Equation 11, max |Sag_O_x_5| means the absolute value of the maximum Sag value in the X-axis direction from the object-side surface of the fifth lens, min |Sag_O_x_5| means an absolute value of a non-zero minimum Sag value in the X-axis direction on the object-side surface of the fifth lens, max |Sag_O_y_5| means an absolute value of a maximum Sag value in the Y-axis direction on the object-side surface of the fifth lens, and min |Sag_O_y_5| means an absolute value of a non-zero minimum Sag value in the Y-axis direction on the object-side surface of the fifth lens.)

As the optical system and optical module according to the embodiment satisfy Equation 11 above, the difference between the Sag value in the X-axis direction and the Sag value in the Y-axis direction of the fifth lens, which is a freeform lens, may be changed. Accordingly, by different optical characteristics of the light passing through the X-axis direction and the light passing through the Y-axis direction of the fifth lens, the relative illumination of the optical system and the optical module may be improved, and the image quality of the peripheral region may be improved.

The optical system and optical module according to the embodiment may satisfy Equation 12 including any one of Equation 12-1, Equation 12-2, and Equation 12-3 below.

$$100 µm \leq max \vert Sag\_O \_x \_ 5 \vert - min \vert Sag\_O \_x \_ 5 \vert \leq 1000 µm 150 µm \leq max \vert Sag\_O \_y \_ 5 \vert - min \vert Sag\_O \_y \_ 5 \vert \leq 950 µm \qquad [ Equation 12 ‐ 1 ]$$

$$300 µm \leq max \vert Sag\_O \_x \_ 5 \vert - min \vert Sag\_O \_x \_ 5 \vert \leq 900 µm 350 µm \leq max \vert Sag\_O \_y \_ 5 \vert - min \vert Sag\_O \_y \_ 5 \vert \leq 850 µm \qquad [ Equation 12 ‐ 2 ]$$

$$500 µm \leq max \vert Sag\_O \_x \_ 5 \vert - min \vert Sag\_O \_x \_ 5 \vert \leq 800 µm 450 µmmm \leq max \vert Sag\_O \_y \_ 5 \vert - min \vert Sag\_O \_y \_ 5 \vert \leq 750 µm \qquad [ Equation 12 ‐ 3 ]$$

As the optical system and optical module according to the embodiment satisfy Equation 12 above, the size of the difference between the Sag value in the X-axis direction and the Sag value in the Y-axis direction of the fifth lens, which is a freeform lens, may be set to a set range. Accordingly, by different optical characteristics of the light passing through the X-axis direction and the light passing through the Y-axis direction of the fifth lens, the relative illumination of the optical system and the optical module may be improved, and the image quality of the peripheral region may be improved.

The optical system and optical module according to the embodiment may satisfy Equation 13 below.

$$\vert max T\_ 4 - min T\_ 4 \vert < \vert max T\_ 5 - min T\_ 5 \vert \qquad [ Equation 13 ]$$

(In Equation 15, max T_4 means the maximum thickness of the fourth lens, min T_4 means the minimum thickness of the fourth lens, max T_5 means the maximum thickness of the fifth lens, and min T_5 means the maximum thickness of the fifth lens)

As the optical system and optical module according to the embodiment satisfy Equation 13 above, the thickness difference between the fifth lens, which is a freeform lens, and the fourth lens disposed adjacent to the fifth lens may be controlled. In detail, the difference between the maximum and minimum thickness of the fourth lens may be made smaller than the difference between the maximum and minimum thickness of the fifth lens. Accordingly, aberrations of the optical system and optical module may be reduced, and image quality in the peripheral region may be improved.

The optical system and optical module according to the embodiment may satisfy Equation 14 below.

$$\vert max T\_ 3 - min T\_ 3 \vert < \vert max T\_ 5 - min T\_ 5 \vert \qquad [ Equation 14 ]$$

(In Equation 15, max T_3 means the maximum thickness of the third lens, min T_3 means the minimum thickness of the third lens, max T_5 means the maximum thickness of the fifth lens, and min T_5 means the maximum thickness of the fifth lens)

As the optical system and optical module according to the embodiment satisfy Equation 14 above, the thickness difference between the fifth lens, which is a freeform lens, and the third lens disposed adjacent to the fifth lens may be controlled. In detail, the difference between the maximum and minimum thickness of the third lens may be made smaller than the difference between the maximum and minimum thickness of the fifth lens. Accordingly, aberrations of the optical system and optical module may be reduced, and image quality in the peripheral region may be improved.

The optical system and optical module according to the embodiment may satisfy Equation 15 below.

$$CT\_ 3 \neq min T\_ 5 , CT\_ 4 \neq min T\_ 4 , CT\_ 5 = min T\_ 5 \qquad [ Equation 15 ]$$

(In Equation 15, CT_3 means the thickness at the optical axis of the third lens, CT_4 means the thickness at the optical axis of the fourth lens, and CT_5 means the thickness at the optical axis of the fifth lens)

As the optical system and optical module according to the embodiment satisfy Equation 15, the thickness of the fifth lens, which is a freeform lens, and the third and fourth lenses disposed adjacent to the fifth lens may be controlled. In detail, the size of the minimum thickness of the third lens may be different from the thickness at the optical axis of the third lens, and the size of the minimum thickness of the fourth lens may be different from the thickness at the optical axis of the fourth lens. The size of the minimum thickness of the fifth lens may be the same as the thickness at the optical axis of the fifth lens. As a result, aberrations in the optical system and optical module may be reduced, and image quality in the peripheral region may be improved.

The optical system and optical module according to the embodiment may satisfy Equation 16, which includes any one of Equation 16-1, Equation 16-2, and Equation 16-3 below.

$$0.3 \leq max D\_ 3 / 4 / min D\_ 3 / 4 \leq 20 \qquad [ Equation 16 ‐ 1 ]$$

$$0.5 \leq max D\_ 3 / 4 / min D\_ 3 / 4 \leq 10 \qquad [ Equation 16 ‐ 2 ]$$

$$1. \leq max D\_ 3 / 4 / min D\_ 3 / 4 \leq 5 \qquad [ Equation 16 ‐ 3 ]$$

(In Equation 16, max D_3/4 means the maximum distance between the third lens and the fourth lens, and min D_3/4 means the minimum distance between the third lens and the fourth lens.)

As the optical system and optical module according to the embodiment satisfy Equation 16 above, the distance between the fifth lens, which is a freeform lens, and the third and fourth lenses disposed adjacent to each other may be set to a set range. Accordingly, aberrations of the optical system and optical module may be reduced, the relative illumination may be increased, and image quality in the peripheral region may be improved.

The optical system and optical module according to the embodiment may satisfy Equation 17 including any one of Equation 17-1, Equation 17-2, and Equation 17-3 below.

$$0.1 \leq max D\_ 4 / 5 / min D\_ 4 / 5 \leq 10 \qquad [ Equation 17 ‐ 1 ]$$

$$0.5 \leq max D\_ 4 / 5 / min D\_ 4 / 5 \leq 5 \qquad [ Equation 17 ‐ 2 ]$$

$$1. \leq max D\_ 4 / 5 / min D\_ 4 / 5 \leq 3 \qquad [ Equation 17 ‐ 3 ]$$

(In Equation 17, max D_4/5 means the maximum distance between the fourth lens and the fifth lens, and min D_4/5 means the minimum distance between the fourth lens and the fifth lens.)

As the optical system and optical module according to the embodiment satisfy Equation 17, the distance between the fifth lens, which is a freeform lens, and the fourth lens disposed adjacent to the fifth lens may be set to a set range. Accordingly, aberrations of the optical system and optical module may be reduced, the relative illumination may be increased, and image quality in the peripheral region may be improved.

The optical system and optical module according to the embodiment may satisfy Equation 18 below.

$$min D\_ 3 / 4 > min T\_ 3 , min D\_ 4 / 5 > min T\_ 5 \qquad [ Equation 18 ]$$

As the optical system and optical module according to the embodiment satisfy Equation 18 above, the respective thicknesses of the fifth lens, which is a freeform lens, and the third lens and fourth lens disposed adjacent to the fifth lens and the distance between the lenses may be controlled. In detail, the minimum distance between the third lens and the fourth lens may be greater than the minimum thickness of the third lens, and the minimum distance between the fourth lens and the fifth lens may be greater than the minimum thickness of the fifth lens. Accordingly, aberrations of the optical system and optical module may be reduced, the relative illumination may be increased, and image quality in the peripheral region may be improved.

The optical system and optical module according to the embodiment may satisfy Equation 19 including any one of Equation 19-1, Equation 19-2, and Equation 19-3 below.

$$10 ° < max \vert SA\_O \_ 3 \vert < 60 ° 10 ° < max \vert SA\_S \_ 3 \vert < 70 ° 0 ° < max \vert SA\_O \_ 3 \vert - max \vert SA\_S \_ 3 \vert < 30 ° \qquad [ Equation 19 ‐ 1 ]$$

$${15}^{∘} < max \vert SA\_O \_ 3 \vert < 50 ° {20}^{∘} < max \vert SA\_S \_ 3 \vert < 60 ° 0 ° < max \vert SA\_O \_ 3 \vert - max \vert SA\_S \_ 3 \vert < 20 ° \qquad [ Equation 19 ‐ 2 ]$$

$${20}^{∘} < max \vert SA\_O \_ 3 \vert < 40 ° {30}^{∘} < max \vert SA\_S \_ 3 \vert < 50 ° 0 ° < max \vert SA\_O \_ 3 \vert - max \vert SA\_S \_ 3 \vert < 15 ° \qquad [ Equation 19 ‐ 3 ]$$

(In Equation 19, max |SA_O_3| means the maximum slope angle between the normal line and the optical axis at any point on the object-side surface in the distance range from the optical axis of the third lens to the effective diameter, and max |SA_S_3| means the maximum slope angle between the normal line and the optical axis at any point on the sensor-side surface in the distance range from the optical axis of the third lens to the effective diameter.)

As the optical system and optical module according to the embodiment satisfy Equation 19 above, the shape of the third lens disposed close to the fifth lens, which is a freeform lens, and the distance between the third lens and the fourth lens may be controlled. In detail, the distance between the fifth lens and the adjacent third and fourth lenses may be adjusted by setting the difference between the maximum slope angle and the maximum slope angle of the third lens to a set range. Accordingly, the aberration of the optical system and optical module may be reduced by adjusting the slope angle of the third lens.

The optical system and optical module according to the embodiment may satisfy Equation 20 including any one of Equation 20-1, Equation 20-2, and Equation 20-3 below.

$$20 ° < max \vert SA\_O \_ 4 \vert < 70 ° 10 ° < max \vert SA\_O \_ 4 \vert < 50 ° 0 ° < max \vert SA\_O \_ 4 \vert - max \vert SA\_O \_ 4 \vert < 35 ° \qquad [ Equation 20 ‐ 1 ]$$

$$30 ° < max \vert SA\_O \_ 4 \vert < 60 ° \\ 15 ° < max \vert SA\_O \_ 4 \vert < 40 ° 0 ° < max \vert SA\_O \_ 4 \vert - max \vert SA\_O \_ 4 \vert < 30 ° \qquad [ Equation 20 ‐ 2 ]$$

$$40 ° < max \vert SA\_O \_ 4 \vert < 50 ° 20 ° < max \vert SA\_O \_ 4 \vert < 30 ° 0 ° < max \vert SA\_O \_ 4 \vert - max \vert SA\_O \_ 4 \vert < 25 ° \qquad [ Equation 20 ‐ 3 ]$$

(In Equation 20, max |SA_O_4| means the maximum slope angle between the normal line and the optical axis at any point on the object-side surface in the distance range from the optical axis of the fourth lens to the effective diameter, and max |SA_S_4| means the maximum slope angle between the normal line and the optical axis at any point on the sensor-side surface in the distance range from the optical axis of the fourth lens to the effective diameter.)

As the optical system and optical module according to the embodiment satisfy Equation 20 above, a shape of the fourth lens disposed close to the fifth lens, which is a freeform lens, may be controlled. In detail, a distance between the fourth lens and the adjacent fifth and fourth lenses may be adjusted by setting the difference between the maximum slope angle and the maximum slope angle of the fourth lens to a set range. Accordingly, the aberration of the optical system and optical module may be reduced by adjusting the slope angle of the fifth lens.

The optical system and optical module according to the embodiment may satisfy Equation 21 including any one of Equation 21-1, Equation 21-2, and Equation 21-3 below.

$$max \vert SA\_O \_ 4 \vert > max \vert SA\_O \_ 3 \vert , max \vert SA\_S \_ 4 \vert < max \vert SA\_S \_ 3 \vert , max \vert SA\_O \_ 4 \vert < 60 ° \\ max \vert SA\_S \_ 4 \vert < 50 ° \qquad [ Equation 21 ‐ 1 ]$$

$$max \vert SA\_O \_ 4 \vert > max \vert SA\_O \_ 3 \vert , max \vert SA\_ 2 \_ 4 \vert < max \vert SA\_S \_ 4 \vert , max \vert SA\_O \_ 4 \vert < 55 ° max \vert SA\_S \_ 4 \vert < 45 ° \qquad [ Equation 21 ‐ 2 ]$$

$$max \vert SA\_O \_ 4 \vert > max \vert SA\_O \_ 3 \vert , max \vert SA\_S \_ 4 \vert < max \vert SA\_S \_ 4 \vert , max \vert SA\_O \_ 4 \vert < 50 ° max \vert SA\_S \_ 4 \vert < 40 ° \qquad [ Equation 21 ‐ 3 ]$$

(In Equation 21, max |SA_O_3| means the maximum slope angle between the normal line and the optical axis at any point on the object-side surface in the distance range from the optical axis of the third lens to the effective diameter, max |SA_S_3| means the maximum slope angle between the normal line and the optical axis at any point on the sensor-side surface in the distance range from the optical axis of the third lens to the effective diameter, max |SA_O_4| means the maximum slope angle between the normal line and the optical axis at any point on the object-side surface in the distance range from the optical axis of the fourth lens to the effective diameter, and max |SA_S_4| means the maximum slope angle between the normal line and the optical axis at any point on the sensor-side surface in the distance range from the optical axis of the fourth lens to the effective diameter.)

As the optical system and optical module according to the embodiment satisfy Equation 21 above, the shapes of the third lens and fourth lens disposed adjacent to the fifth lens, which is a freeform lens, may be controlled. In detail, the maximum slope angle of the object-side surface of the fourth lens may be greater than the maximum slope angle of the object-side surface of the third lens, and the maximum slope angle of the sensor-side surface of the fourth lens may be less than the maximum slope angle of the sensor side surface of the third lens.)

Accordingly, the distance between the fifth lens and the adjacent third and fourth lenses may be adjusted. Accordingly, the slope angles of the fifth lens, which is a freeform lens, and the third and fourth lenses, which are adjacent lenses, may be adjusted to reduce aberrations in the optical system and optical module.

The optical system and optical module according to the embodiment may satisfy Equation 22 below.

$$P\_ 1 is positive ( + ) , P\_ 2 is negative ( - ) , \\ P\_ 5 is negative ( - ) \qquad [ Equation 22 ]$$

(In Equation 22, P_1 means a refractive power sign of the first lens, P_2 means a refractive power sign of the second lens, and P_5 means to a refractive power sign of the fifth lens.)

As the optical system and optical module according to the embodiment satisfy Equation 22 above, the TTL size of the optical system module may be reduced, and the effective diameter of the object-side surface of the lenses may be reduced. As a result, the optical system and optical module may be easily applied to display devices such as smartphones, resolution may be improved, and image quality in the peripheral region may be improved.

The optical system and optical module according to the embodiment may satisfy Equation 23 including any one of Equation 23-1, Equation 23-2, and Equation 23-3 below.

$$FOV ( θ ) \leq 90 ° , \\ 1 \leq CA\_O \_ 5 / CA\_O \_x \leq 3.5 \qquad [ Equation 23 ‐ 1 ]$$

$$FOV ( θ ) \leq 90 ° , \\ 1.3 \leq CA\_O \_ 5 / CA\_O \_x \leq 3.3 \qquad [ Equation 23 ‐ 2 ]$$

$$FOV ( θ ) \leq 90 ° , \\ 1.5 \leq CA\_O \_ 5 / CA\_O \_x \leq 3. \qquad [ Equation 23 ‐ 3 ]$$

(In Equation 23, FOV means the effective angle of view of the optical system, CA_O_x means the effective diameter of the object-side surface of the lens closest to the aperture stop, and CA_O_5 means the effective diameter of the object-side surface of the fifth lens.)

As the optical system and optical module according to the embodiment satisfy Equation 23 above, the aberration characteristics and resolution of the optical system and the optical module may be improved by adjusting an effective diameter ratio of the lens having a large effective diameter, a sensitive optical characteristic, and a relatively non-sensitive lens within the set effective angle of view range.

The optical system and optical module according to the embodiment may satisfy Equation 24 below.

$$P\_ 1 sign \neq P\_ 2 sign , V\_ 1 > V\_ 2 , 10 < V 2 < 50 < V 1 , N\_ 1 < N\_ 2 \qquad [ Equation 24 ]$$

(In Equation 24, P_1 sign is a refractive power sign of the first lens having a positive (+) or negative (−) sign, P_2 sign is a refractive power sign of the second lens having a positive (+) or negative (−) sign, V_1 is an Abbe number of the first lens, V_2 is an Abbe number of the second lens, N_1 is a refractive index of the first lens, and N_2 is a refractive index of the second lens.)

As the optical system and optical module according to the embodiment satisfy Equation 24 above, the refractive indices and Abbe numbers of the first lens and the second lens may be set to a set range, thereby improving the chromatic aberration of the optical system and optical module.

The optical system and optical module according to the embodiment may satisfy Equation 25 including any one of Equation 25-1, Equation 25-2, and Equation 25-3 below.

$$1. \leq \vert EFL / f\_ 3 \vert + \vert EFL / f\_ 4 \vert + \vert EFL / f\_ 5 \vert \leq 10 \text{.00} \qquad [ Equation 25 ‐ 1 ]$$

$$2. \leq \vert EFL / f\_ 3 \vert + \vert EFL / f\_ 4 \vert + \vert EFL / f\_ 5 \vert \leq 7. \qquad [ Equation 25 ‐ 2 ]$$

$$3. 00 \leq \vert EFL / f\_ 3 \vert + \vert EFL / f\_ 4 \vert + \vert EFL / f\_ 5 \vert \leq 5. \qquad [ Equation 25 ‐ 3 ]$$

(In Equation 25, f_3 means a focal length of the third lens, f_4 means a focal length of the fourth lens, and f_5 means a focal length of the fifth lens.)

As the optical system and optical module according to the embodiment satisfy Equation 25 above, since a ratio of the effective focal lengths to the sequentially disposed third, fourth, and fifth lenses has a set range, aberration characteristics of the optical system and the optical module may be improved.

The optical system and optical module according to the embodiment may satisfy Equation 26 including any one of Equation 26-1, Equation 26-2, and Equation 26-3 below.

$$1 \leq \vert f\_ 1 / f\_ 2 \vert + \vert f\_ 1 / f\_ 3 \vert + \vert f\_ 1 / f\_ 4 \vert + \vert f\_ 1 / f\_ 5 \vert \leq 15 \qquad [ Equation 26 ‐ 1 ]$$

$$2 \leq \vert f\_ 1 / f\_ 2 \vert + \vert f\_ 1 / f\_ 3 \vert + \vert f\_ 1 / f\_ 4 \vert + \vert f\_ 1 / f\_ 5 \vert \leq 10 \qquad [ Equation 26 ‐ 2 ]$$

$$3 \leq \vert f\_ 1 / f\_ 2 \vert + \vert f\_ 1 / f\_ 3 \vert + \vert f\_ 1 / f\_ 4 \vert + \vert f\_ 1 / f\_ 5 \vert \leq 5 \qquad [ Equation 26 ‐ 3 ]$$

(In Equation 26, f_1 means a focal length of the first lens, f_2 means a focal length of the second lens, f_3 means a focal length of the third lens, f_4 means a focal length of the fourth lens, and f_5 means a focal length of the fifth lens.)

As the optical system and optical module according to the embodiment satisfy Equation 26 above, since the ratio of the effective focal length to the sequentially disposed first lens, second lens, third lens, fourth lens, and fifth lens has a set range, aberration characteristics of the optical system and the optical module may be improved.

The optical system and optical module according to the embodiment may satisfy Equation 27 including any one of Equation 27-1, Equation 27-2, and Equation 27-3 below.

$$10 < \vert f\_ 3 / CT\_ 3 \vert \leq 200 \qquad [ Equation 27 ‐ 1 ]$$

$$30 \leq \vert f\_ 3 / CT\_ 3 \vert \leq 150 \qquad [ Equation 27 ‐ 2 ]$$

$$50 \leq \vert f\_ 3 / CT\_ 3 \vert \leq 100 \qquad [ Equation 27 ‐ 3 ]$$

(In Equation 27, f_3 means the focal length of the third lens, and CT_3 means the thickness at the optical axis of the third lens.)

As the optical system and optical module according to the embodiment satisfy Equation 27 above, since a ratio of the focal length of the third lens disposed adjacent to the fifth lens, which is a freeform lens, and the thickness in the optical axis have a set range, aberration characteristics of the optical system and the optical module may be improved.

The optical system and optical module according to the embodiment may satisfy Equation 28 including any one of Equation 28-1, Equation 28-2, and Equation 28-3 below.

$$1 < \vert f\_ 4 / CT\_ 4 \vert \leq 20 \qquad [ Equation 28 ‐ 1 ]$$

$$2 \leq \vert f\_ 4 / CT\_ 4 \vert \leq 15 \qquad [ Equation 28 ‐ 2 ]$$

$$3 \leq \vert f\_ 4 / CT\_ 4 \vert \leq 10 \qquad [ Equation 28 ‐ 3 ]$$

(In Equation 28, f_4 means the focal length of the fourth lens, and CT_4 means the thickness at the optical axis of the fourth lens.)

As the optical system and optical module according to the embodiment satisfy Equation 28 above, a ratio of the focal length of the fourth lens disposed adjacent to the fifth lens, which is a freeform lens, and the thickness in the optical axis have a set range, aberration characteristics of the optical system and the optical module may be improved.

The optical system and optical module according to the embodiment may satisfy Equation 29 including any one of Equation 29-1, Equation 29-2, and Equation 29-3 below.

$$0.2 \leq CT\_ 4 / CT\_ 3 \leq 2.5 \qquad [ Equation 29 ‐ 1 ]$$

$$0.5 \leq CT\_ 4 / CT\_ 3 \leq 2. \qquad [ Equation 29 ‐ 2 ]$$

$$0.7 \leq CT\_ 4 / CT\_ 3 \leq 1.5 \qquad [ Equation 29 ‐ 3 ]$$

(In Equation 29, CT_3 means the thickness at the optical axis of the third lens, and CT_4 means the thickness at the optical axis of the fourth lens.)

As the optical system and optical module according to the embodiment satisfy Equation 29 above, a ratio of the thickness of the third lens and the fourth lens disposed adjacent to the fifth lens, which is a freeform lens, in the optical axis have a set range, aberration characteristics of the optical system and the optical module may be improved.

The optical system and optical module according to the embodiment may satisfy Equation 30 including any one of Equation 30-1, Equation 30-2, and Equation 30-3 below.

$$0.3 \leq TTL / EFL \leq 2. \qquad [ Equation 30 ‐ 1 ]$$

$$0.5 \leq TTL / EFL \leq 1.7 \qquad [ Equation 30 ‐ 2 ]$$

$$0.8 \leq TTL / EFL \leq 1.5 \qquad [ Equation 30 ‐ 3 ]$$

(In Equation 30, TTL (Total track length) means a distance in the optical axis OA direction from the vertex of the object-side surface of the first lens to the image surface of the image sensor unit, and EFL means the effective focal length of the optical system.)

As the optical system and optical module according to the embodiment satisfy Equation 30 above, a ratio of TTL and effective focal length have a set range, so that the optical system and the optical module may be slimly implemented so as to have an appropriate size, and aberration characteristics may be improved.

The optical system and optical module according to the embodiment may satisfy Equation 31 including any one of Equation 31-1, Equation 31-2, and Equation 31-3 below.

$$20 < V 4 + V 5 < 150 \qquad [ Equation 31 ‐ 1 ]$$

$$30 < V 4 + V 5 < 130 \qquad [ Equation 31 ‐ 2 ]$$

$$40 < V 4 + V 5 < 110 \qquad [ Equation 31 ‐ 3 ]$$

(In Equation 31, V4 means an Abbe number of the fourth lens, and V5 means an Abbe number of the fifth lens.)

As the optical system and optical module according to the embodiment satisfy Equation 31 above, since a magnitude of the Abbe numbers of the fourth and fifth lenses disposed close to the image sensor unit have a set range, the aberration characteristics of the optical system and optical module may be improved.

The optical system and optical module according to the embodiment may satisfy Equation 32 including any one of Equation 32-1, Equation 32-2, and Equation 32-3 below.

$$3.5 < TTL < 8. \qquad [ Equation 32 ‐ 1 ]$$

$$3. 8 < TTL < 7. \qquad [ Equation 32 ‐ 2 ]$$

$$4. 2 < TTL < 6. \qquad [ Equation 32 ‐ 3 ]$$

(In Equation 32, TTL (Total track length) means a distance in the optical axis direction from the vertex of the object-side surface of the first lens to the image surface of the image sensor unit.)

As the optical system and optical module according to the embodiment satisfy Equation 32 above, since the miniaturization of the optical system and the optical module according to the configuration may be implemented by setting the size of the TTL to a set range, the optical system and the optical module according to the configuration may be easily applied to a display device such as a smartphone.

The optical system and optical module according to the embodiment may satisfy Equation 33 including any one of Equation 33-1, Equation 33-2, and Equation 33-3 below.

$$1.5 < TTL / EPD < 4 \qquad [ Equation 33 ‐ 1 ]$$

$$1.8 < TTL / EPD < 3 \qquad [ Equation 33 ‐ 2 ]$$

$$2. < TTL / EPD < 2.7 \qquad [ Equation 33 ‐ 3 ]$$

(In Equation 33, TTL (Total track length) means the distance in the optical axis direction from the vertex of the object-side surface of the first lens to the image surface of the image sensor unit, and EPD means the size of the entrance pupil diameter of the optical system.)

As the optical system and optical module according to the embodiment satisfy Equation 33 above, the resolution of the optical system and optical module may be improved by setting the TTL and the size of the entrance pupil diameter to a set range.

The optical system and optical module according to the embodiment may satisfy Equation 34 including any one of Equation 34-1, Equation 34-2, and Equation 34-3 below.

$$1 < F number < 3.5 \qquad [ Equation 34 ‐ 1 ]$$

$$1.5 < F number < 3. \qquad [ Equation 34 ‐ 2 ]$$

$$1.7 < F number < 2.5 \qquad [ Equation 34 ‐ 3 ]$$

As the optical system and optical module according to the embodiment satisfy Equation 34 above, the resolution of the optical system and optical module may be improved by setting the size of the F number to a set range.

The optical system and optical module according to the embodiment may satisfy Equation 35 including any one of Equation 35-1, Equation 35-2, and Equation 35-3 below.

$$0.5 mm < D\_mx \_ 5 / I < 2. mm \qquad [ Equation 35 ‐ 1 ]$$

$$0.65 mm < D\_mx \_ 5 / I < 1.8 mm \qquad [ Equation 35 ‐ 2 ]$$

$$0.8 mm < D\_mx \_ 5 / I < 1.5 mm \qquad [ Equation 35 ‐ 3 ]$$

(In Equation 35, D_mx_5/I means a distance in the optical axis direction from the point having the absolute value of the maximum Sag value on the sensor-side surface of the fifth lens to the image surface of the image sensor unit.)

As the optical system and optical module according to the embodiment satisfy the above equation 35, since the distance between the fifth lens, which is the last lens of the optical system, and the image sensor unit may be set to a set range, it is possible to facilitate the manufacture of an optical system and an optical module, and to improve optical characteristics by minimizing interference between the image sensor unit and the optical system.

The optical system 1000 and the optical module 2000 according to embodiments may satisfy at least one of Equations 1 to 35 described above. In detail, the optical system 1000 and the optical module 2000 according to the embodiment may satisfy any one of the above equations or a combination of at least two of the above equations.

As the optical system 1000 and the optical module 2000 according to the embodiment satisfy any one of the above equations or a combination of at least two or more equations, the optical system 1000 and the optical module 2000 have improved optical characteristics. Additionally, the optical system 1000 and the optical module 2000 may minimize optical distortion in image results. Additionally, small optical systems and optical modules may be implemented. Additionally, chromatic aberration of the optical system 1000 and the optical module 2000 may be reduced, and the relative illumination may be increased to improve peripheral image quality.

below. The optical system and optical module according to embodiments will be described with reference to the drawings.

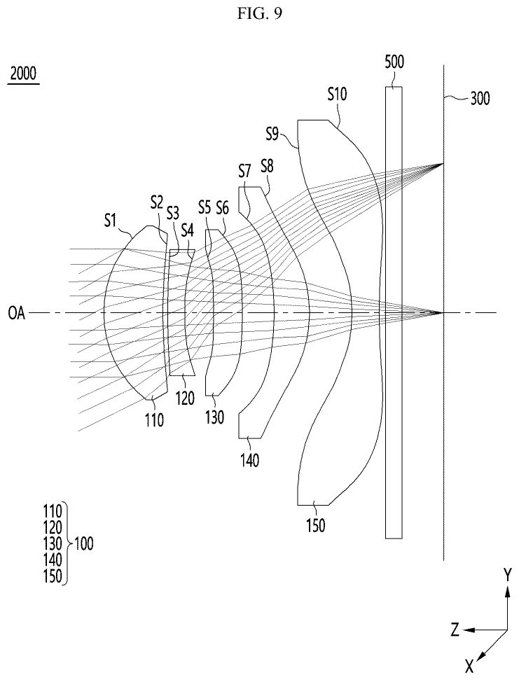

First, the optical system 1000 and the optical module 2000 according to the first embodiment will be described in more detail with reference to FIGS. 9 to 20.

Referring to FIG. 9, the optical system 1000 and optical module 2000 according to the first embodiment may include five lenses.

In detail, the optical system 1000 and the optical module 2000 according to the first embodiment may include a first lens 110, a second lens 120, a third lens 130, a fourth lens 140, a fifth lens 150, and an image sensor unit 300 sequentially disposed from the object side to the sensor side. The first lens 110, the second lens 120, the third lens 130, the fourth lens 140, and the fifth lens 150 may be arranged sequentially disposed along the optical axis of the optical system 1000 and spaced apart from each other.

Additionally, a filter unit 500 may be disposed between the plurality of lenses 110, 120, 130, 140, and 150 and the image sensor unit 300. The filter unit 500 may be disposed between the fifth lens 150 and the image sensor unit 300.

Additionally, the optical system 1000 according to the first embodiment may include an aperture stop (not shown). The aperture stop may be disposed between the first lens 110 and the second lens 120. Alternatively, the sensor-side surface of the first lens 110 may serve as an aperture stop.

The first to fifth lenses 110, 120, 130, 140, and 150 according to the first embodiment each may have a radius of curvature, thickness, distance, refractive index, and Abbe number.

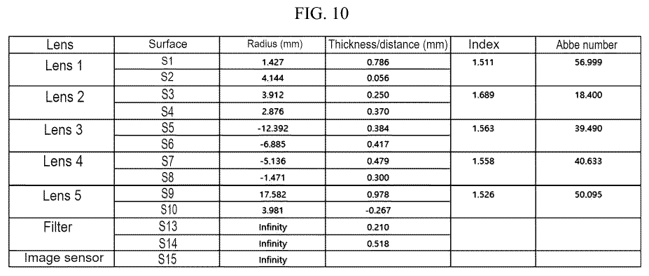

In detail, the radius of curvature, thickness, distance, refractive index, and Abbe number of the first to fifth lenses 110, 120, 130, 140, and 150 according to the first embodiment may be as shown in FIG. 10.

Referring to FIGS. 9 and 10, in the optical system 1000 according to the first embodiment, the first lens 110 may have positive (+) refractive power on the optical axis. The first surface S1 of the first lens 110 may be convex with respect to the object side on the optical axis, and the second surface S2 may be concave with respect to the sensor side on the optical axis. The first lens 110 may have an overall meniscus shape convex toward the object on the optical axis. The first surface S1 may be an aspherical surface, and the second surface S2 may be an aspherical surface.

The second lens 120 may have negative refractive power on the optical axis. The third surface S3 of the second lens 120 may be convex with respect to the object side on the optical axis, and the fourth surface S4 may be concave with respect to the sensor side on the optical axis. The second lens 120 may have an overall meniscus shape convex toward the object on the optical axis. The third surface S3 may be an aspherical surface, and the fourth surface S4 may be an aspherical surface.

The third lens 130 may have positive (+) refractive power on the optical axis. The fifth surface S5 of the third lens 130 may be concave with respect to the object side on the optical axis, and the sixth surface S6 may be convex with respect to the sensor side on the optical axis. The third lens 130 may have an overall meniscus shape convex from the optical axis toward the sensor. The fifth surface S5 may be an aspherical surface, and the sixth surface S6 may be an aspherical surface.

The fourth lens 140 may have positive (+) refractive power on the optical axis. The seventh surface S7 of the fourth lens 140 may be concave with respect to the object side on the optical axis, and the eighth surface S8 may be convex with respect to the sensor side on the optical axis. The fourth lens 140 may have an overall meniscus shape convex toward the sensor side on the optical axis.

The seventh surface S7 may be an aspherical surface, and the eighth surface S8 may be an aspherical surface.

The fifth lens 150 may have negative refractive power on the optical axis. The ninth surface S9 of the fifth lens 150 may be convex with respect to the object-side surface of the optical axis, and the tenth surface S10 may be concave with respect to the sensor side on the optical axis. The fifth lens 150 may have an overall meniscus shape convex toward the object side on the optical axis.

At least one of the ninth surface S9 and the tenth surface S10 may include a freeform surface. In detail, the ninth surface S9 and the tenth surface S10 may include freeform surfaces. That is, the fifth lens 150 may be a freeform lens.

The freeform shape of the fifth lens 150 may be defined by the Sag value calculated by Equation D.

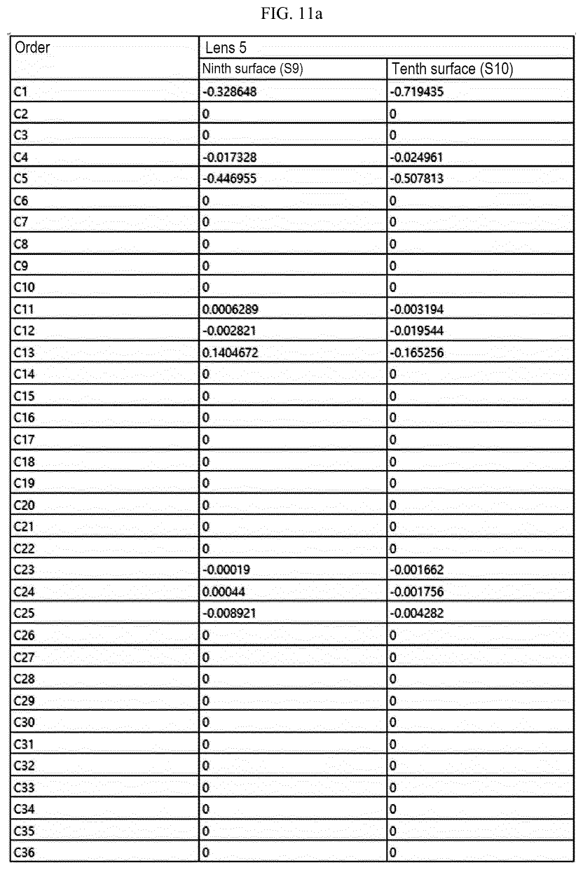

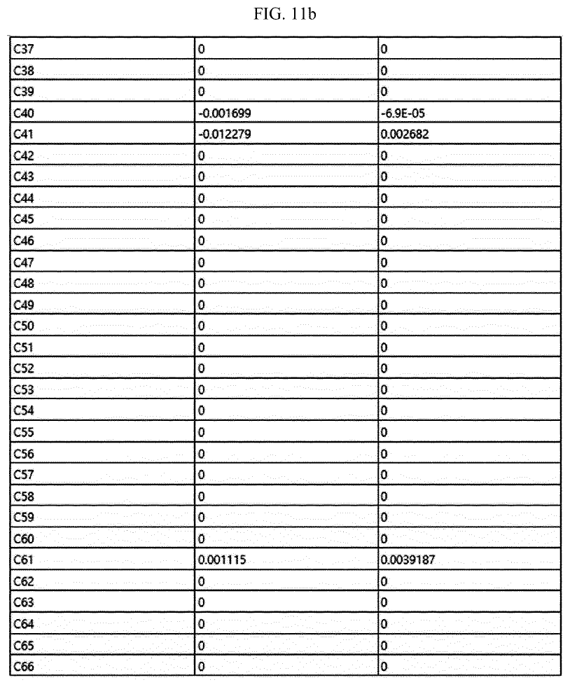

In detail, the fifth lens 150 may include orders in which the Zernike coefficients of FIG. 11 have a value of 0 and orders that have a value other than 0.

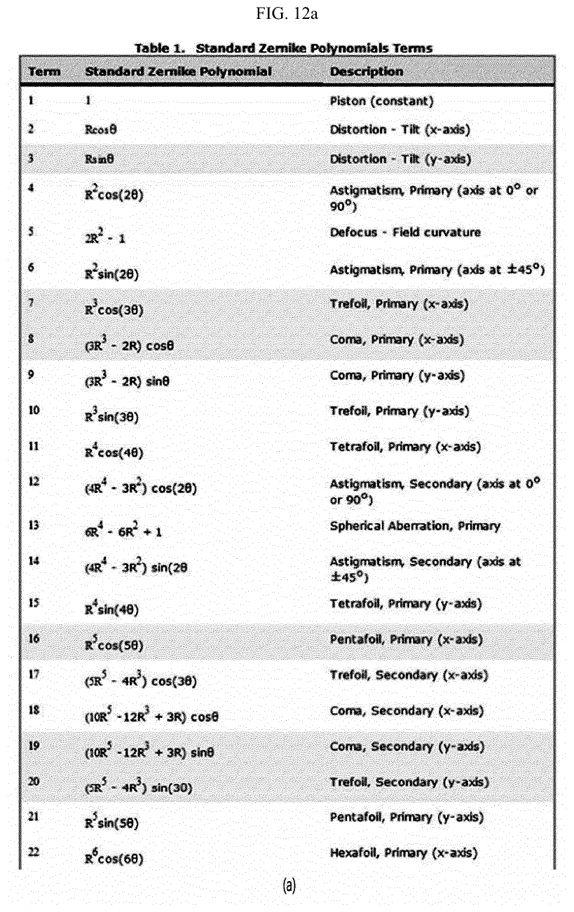

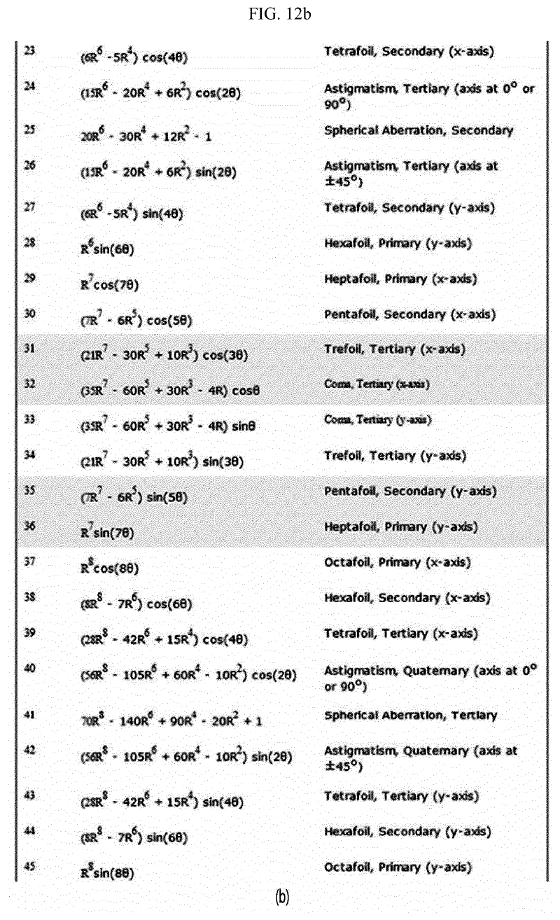

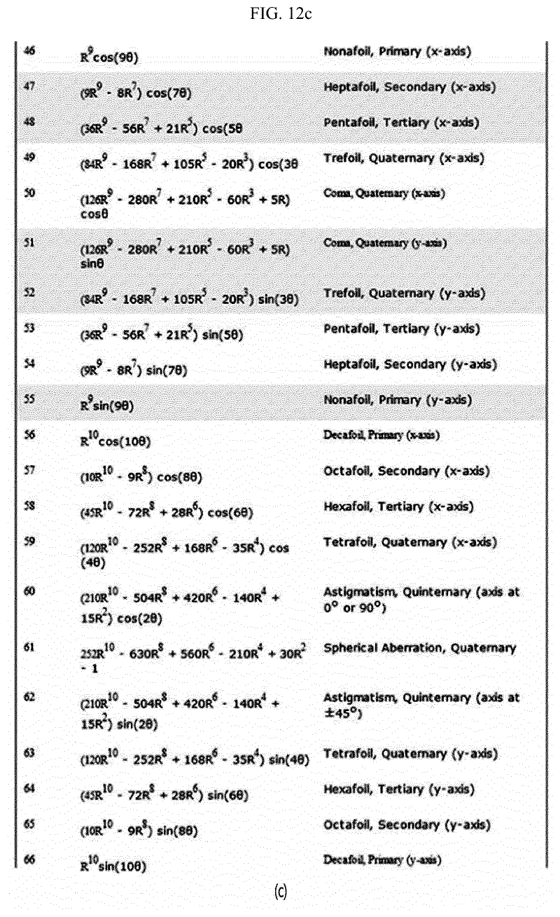

In detail, in FIG. 12, the fifth lens 150 may manufacture the fifth lens by setting all orders having Sine and Cos θ to a value of 0, and adjusts some of the orders having Cos 2nθ to non-zero values.

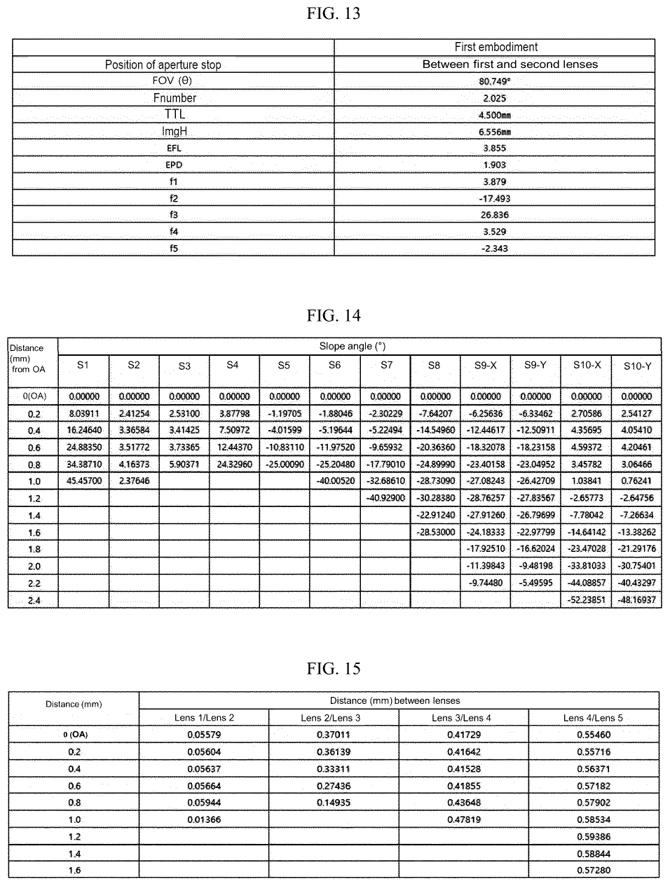

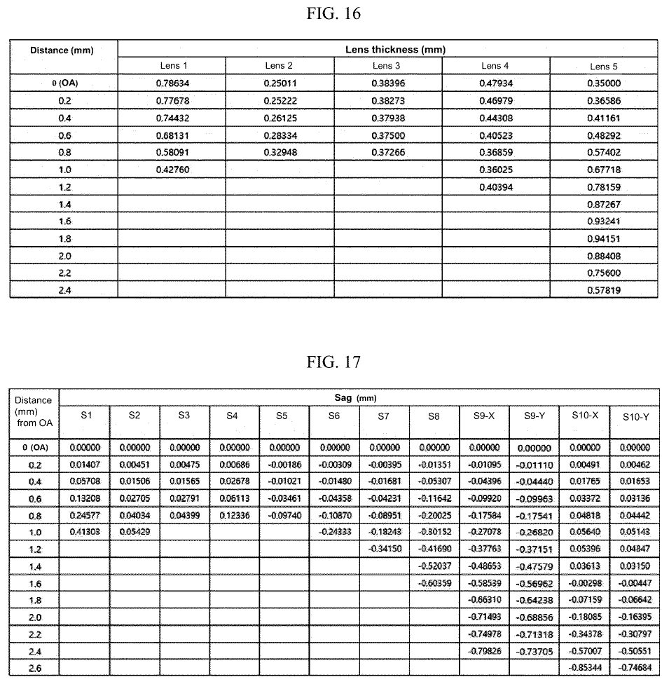

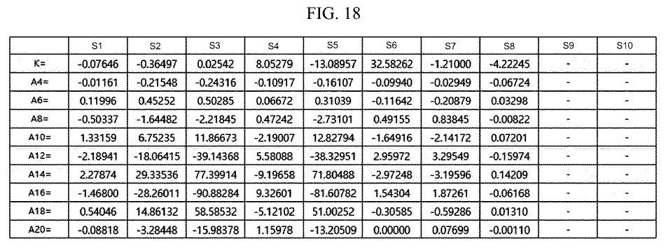

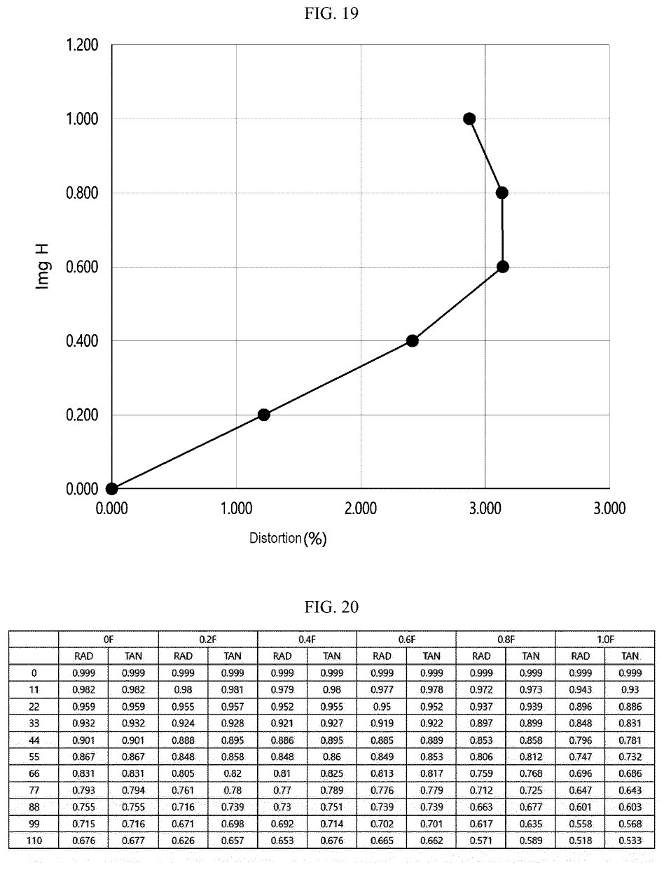

FIG. 13 shows the numerical values of items applied to the above equations in the optical system 1000 and optical module 2000 according to the first embodiment, FIG. 14 shows slope angles for each position of the first to fifth lenses in the optical system according to the first embodiment, FIG. 15 shows lens intervals for each position of the first to fifth lenses in the optical system according to the first embodiment, FIG. 16 shows lens thickness for each position of the first to fifth lenses in the optical system according to the first embodiment, FIG. 17 shows Sag values for each position of the first to fifth lenses in the optical system according to the first embodiment, FIG. 18 shows aspherical coefficient values of the optical system 1000 according to the first embodiment, FIG. 19 shows a graph showing a degree of distortion of the optical system and the optical module according to the first embodiment, and FIG. 20 shows a table for explaining MTF characteristics of the optical system and the optical module according to the first embodiment.

Referring to FIG. 14, it may be seen that in the optical system and optical module according to the first embodiment, the first to fifth lenses are formed at different slope angles for each position.

Additionally, it may be seen that the slope angles of the first to fifth lenses gradually increases as they move away from the optical axis. That is, it may be seen that the first to fifth lenses have the largest slope angle at the end of the effective diameter.

Additionally, it may be seen that the slope angles of the first to fifth lenses increases as they move away from the optical axis. That is, it may be seen that the curvature of the overall lens surface of the first to fifth lenses increases as they move away from the optical axis.

Additionally, it may be seen that at least one lens among the first to fifth lenses includes a region where a sign of the slope angle changes. That is, it may be seen that at least one lens among the first to fifth lenses includes a critical point.

For example, in an optical module, the sensor-side surface of the fifth lens includes a critical point located at a distance of more than 30% to 50% of the effective radius of the fifth lens from the optical axis.

Additionally, it may be seen that at least one lens among the first to fifth lenses includes a region where the size of the slope angle decreases.

Referring to FIG. 15, in the optical system and the optical module according to the first embodiment, it may be seen that the first to fifth lenses are formed at different lens intervals at each position.

Additionally, at least one lens among the first to fifth lenses may include a region where the size of the lens interval is reduced. For example, an interval between the second lens and the third lens, an interval between the third lens and the fourth lens, and an interval between the fourth lens and the fifth lens may include a region in which the size of the lens interval decreases.

Additionally, at least one lens among the first to fifth lenses may include a region where the size of the lens interval increases. For example, the interval between the first lens and the second lens, the interval between the third lens and the fourth lens, and the interval between the fourth lens and the fifth lens may include a region in which the size of the lens interval increases.

Additionally, the region where the size of the lens interval decreases may be larger than the region where the size of the lens interval of at least one lens among the first to fifth lenses increases. For example, the interval between the second lens and the third lens may be larger in a region where the size of the lens interval decreases than a region where the size of the lens interval increases.

Additionally, the region where the lens interval increases in at least one lens among the first to fifth lenses may be larger than the region where the lens interval decreases. For example, the interval between the first lens and the second lens and the interval between the third lens and the fourth lens may be larger in a region where the size of the lens interval increases than a region where the size of the lens interval decreases.

Additionally, at least one lens among the first to fifth lenses may include only a region where the size of the lens interval decreases. For example, the interval between the second lens and the third lens may include only a region where the size of the lens interval decreases.

Additionally, at least one lens among the first to fifth lenses may include only a region where the size of the lens interval increases. For example, the interval between the first lens and the second lens and the interval between the third lens and the fourth lens may include only a region where the size of the lens interval increases.

Referring to FIG. 16, it may be seen that in the optical system and optical module according to the first embodiment, the first to fifth lenses are formed with different lens thicknesses at each position.

Additionally, at least one lens among the first to fifth lenses may include a region where the lens thickness decreases. For example, the first lens, the third lens, the fourth lens, and the fifth lens may include a region where the lens thickness is reduced.

Additionally, at least one lens among the first to fifth lenses may include a region where the lens thickness increases. For example, the second lens, the fourth lens, and the fifth lens may include a region where the lens thickness increases.

Additionally, the region where lens thickness decreases may be larger than the region where lens thickness increases in at least one lens among the first to fifth lenses. For example, the region where the thickness of the first lens, the third lens, and the fourth lens decreases may be larger than the region where the thickness increases.

Additionally, the region where the lens thickness increases in at least one lens among the first to fifth lenses may be larger than the region where the lens thickness decreases. For example, the region where the thickness of the second lens increases may be larger than the region where the thickness decreases.

Additionally, at least one lens among the first to fifth lenses may include only a region where the lens thickness decreases. For example, the first lens and the third lens may include only a region where the lens thickness decreases.

Additionally, at least one lens among the first to fifth lenses may include only a region where the lens thickness increases. For example, the second lens may include only a region where the lens thickness increases.

Referring to FIG. 17, it may be seen that the optical system and optical module according to the first embodiment are formed with the first to fifth lenses having different Sag values at each position.

Additionally, at least one lens among the first to fifth lenses may include a region where the size of the Sag value increases. For example, the first and second surfaces of the first lens, the third and fourth surfaces of the second lens, the fifth and sixth surfaces of the third lens, the seventh and eighth surfaces of the fourth lens, and the ninth and tenth surfaces of the fifth lens may include a region where the Sag value increases.

Additionally, the region where the Sag value increases in at least one lens among the first to fifth lenses may be larger than the region where the Sag value decreases. For example, the first and second surfaces of the first lens, the third and fourth surfaces of the second lens, the fifth and sixth surfaces of the third lens, the seventh and eighth surfaces of the fourth lens, and the ninth and tenth surfaces of the fifth lens may be larger than the region in which the Sag value increases may be larger region in which the Sag value increases than in which the Sag value decreases.

Additionally, at least one lens among the first to fifth lenses may include only a region where the Sag value increases. For example, the first and second surfaces of the first lens, the third and fourth surfaces of the second lens, the fifth and sixth surfaces of the third lens, the seventh and eighth surfaces of the fourth lens, and the ninth and tenth surfaces of the fifth lens may include only regions in which the thickness of the lens increases.

In the optical system 1000 and the optical module 2000 according to the first embodiment, the numerical values of FIG. 13 may satisfy at least one of Equations 1 to 35. In detail, the optical system 1000 and the optical module 2000 according to the first embodiment may satisfy all of Equations 1 to 35 above.

Accordingly, it may be seen that the optical system and optical module according to the first embodiment may have low distortion characteristics as shown in FIG. 19.

Additionally, it may be seen that the optical system and optical module according to the first embodiment have improved MTF characteristics as shown in FIG. 20.

Hereinafter, the optical system 1000 and the optical module 2000 according to the second embodiment will be described in more detail with reference to FIGS. 21 to 31.

Referring to FIG. 21, the optical system 1000 and optical module 2000 according to the second embodiment may include five lenses.

In detail, the optical system 1000 and the optical module 2000 according to the second embodiment include a first lens 110, a second lens 120, a third lens 130, a fourth lens 140, a fifth lens 150, and an image sensor unit 300 arranged sequentially from the object side toward the sensor side. The first lens 110, the second lens 120, the third lens 130, the fourth lens 140, and the fifth lens 150 may be arranged sequentially disposed along the optical axis of the optical system 1000 and spaced apart from each other.

Additionally, a filter unit 500 may be disposed between the plurality of lenses 110, 120, 130, 140, and 150 and the image sensor unit 300. The filter unit 500 may be disposed between the fifth lens 150 and the image sensor unit 300.

Additionally, the optical system 1000 according to the second embodiment may include an aperture stop (not shown). The aperture stop may be disposed between the first lens 110 and the second lens 120. Alternatively, the sensor-side surface of the first lens 110 may serve as an aperture stop.

The first to fifth lenses 110, 120, 130, 140, and 150 according to the second embodiment each may have a radius of curvature, thickness, distance, refractive index, and Abbe number.

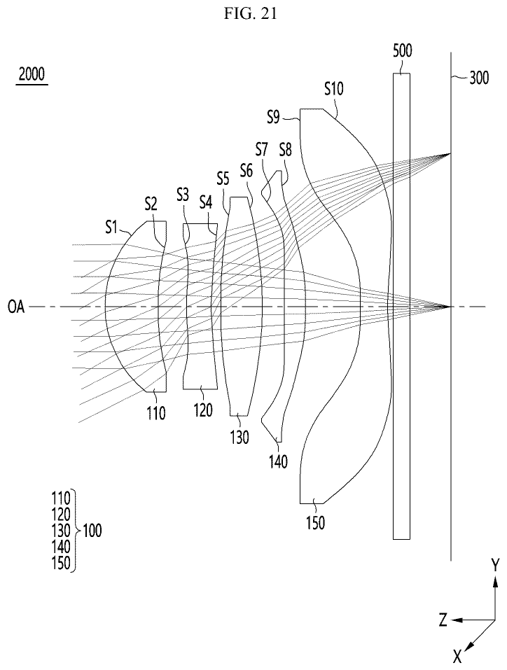

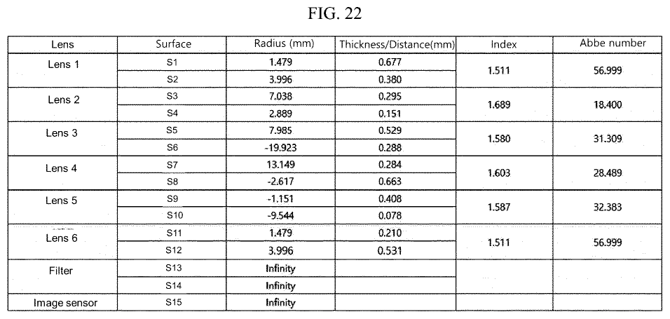

In detail, the radius of curvature, thickness, distance, refractive index, and Abbe number of the first to fifth lenses 110, 120, 130, 140, and 150 according to the second embodiment may be as shown in FIG. 22.

Referring to FIGS. 21 and 22, in the optical system 1000 according to the second embodiment, the first lens 110 may have positive refractive power on the optical axis. The first surface S1 of the first lens 110 may be convex with respect to the object side on the optical axis, and the second surface S2 may be concave with respect to the sensor side on the optical axis. The first lens 110 may have an overall meniscus shape convex from the optical axis toward the object side. The first surface S1 may be an aspherical surface, and the second surface S2 may be an aspherical surface.

The second lens 120 may have negative refractive power on the optical axis. The third surface S3 of the second lens 120 may be convex with respect to the object side on the optical axis, and the fourth surface S4 may be concave with respect to the sensor side on the optical axis. The second lens 120 may have an overall meniscus shape convex from the optical axis toward the object. The third surface S3 may be an aspherical surface, and the fourth surface S4 may be an aspherical surface.

The third lens 130 may have positive (+) refractive power on the optical axis. The fifth surface S5 of the third lens 130 may be convex with respect to the object side on the optical axis, and the sixth surface S6 may be convex with respect to the sensor side on the optical axis. The third lens 130 may have an overall shape in which both sides are convex on the optical axis. The fifth surface S5 may be an aspherical surface, and the sixth surface S6 may be an aspherical surface.

The fourth lens 140 may have positive (+) refractive power on the optical axis. The seventh surface S7 of the fourth lens 140 may be concave with respect to the object side on the optical axis, and the eighth surface S8 may be convex with respect to the sensor side on the optical axis. The fourth lens 140 may have an overall shape in which both sides are convex on the optical axis. The seventh surface S7 may be an aspherical surface, and the eighth surface S8 may be an aspherical surface.

The fifth lens 150 may have negative refractive power on the optical axis. The ninth surface S9 of the fifth lens 150 may be concave with respect to the object side on the optical axis, and the tenth surface S10 may be convex with respect to the sensor side on the optical axis. The fifth lens 10 may have a meniscus shape that is generally convex toward the sensor side.

At least one of the ninth surface S9 and the tenth surface S10 may include a freeform surface. In detail, the ninth surface S9 and the tenth surface S10 may include freeform surfaces. That is, the fifth lens 150 may be a freeform lens.

The freeform shape of the fifth lens 150 may be defined by the Sag value calculated by Equation D.

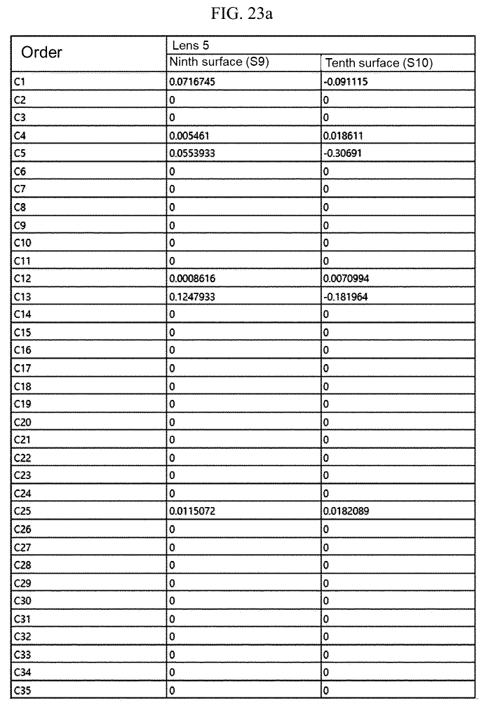

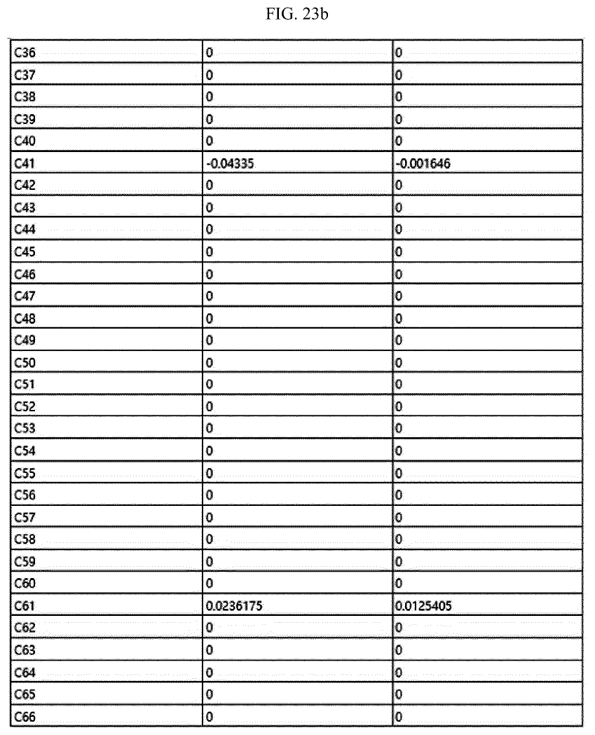

In detail, the fifth lens 150 may include orders in which the Zernike coefficients of FIG. 23 have a value of 0 and orders that have a value other than 0.

In detail, in FIG. 12, the fifth lens 150 may manufacture the fifth lens by setting all orders having Sin θ and Cos θ to a value of 0, and adjusts some of the orders having Cos 2nθ to non-zero values.

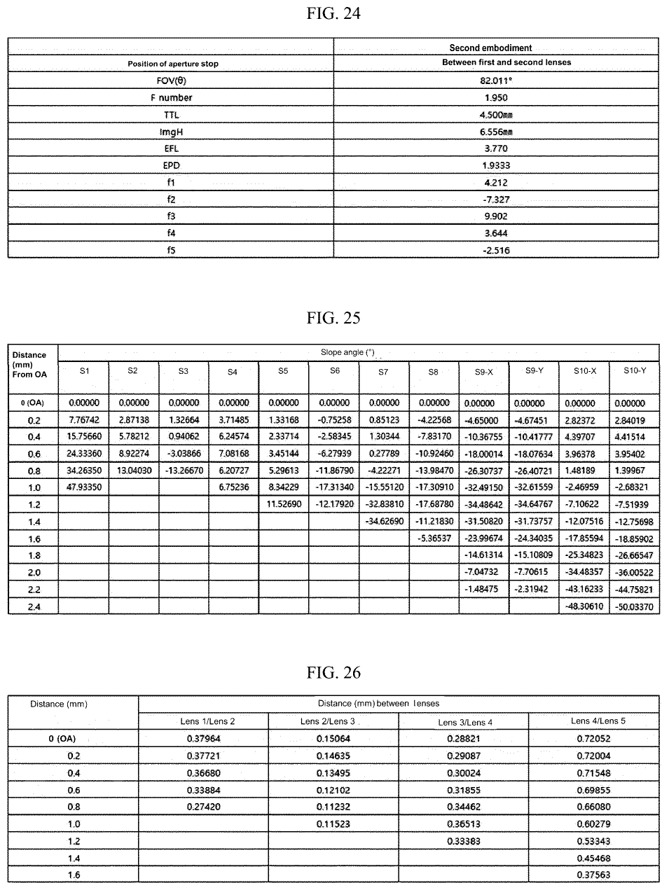

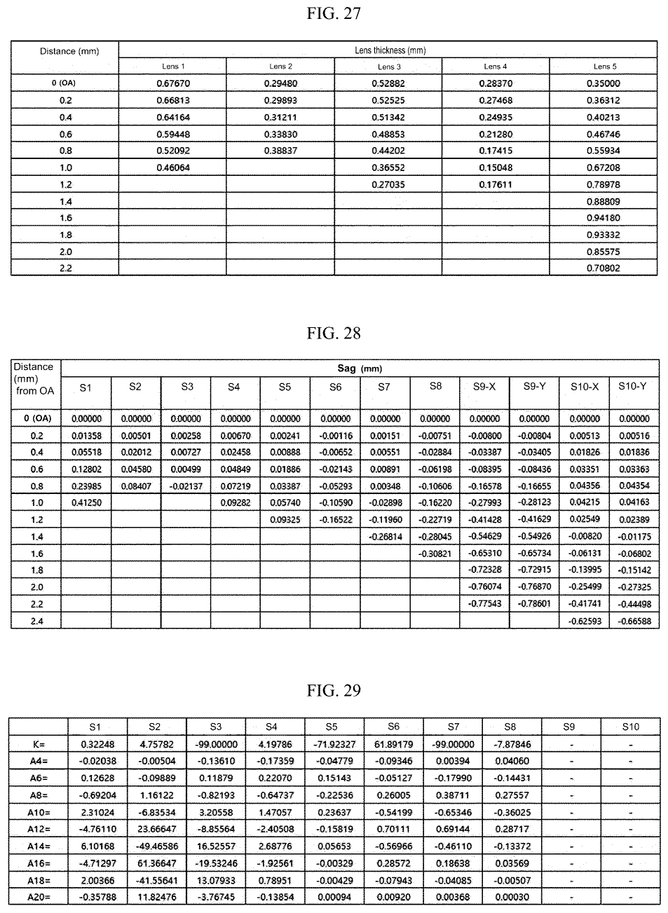

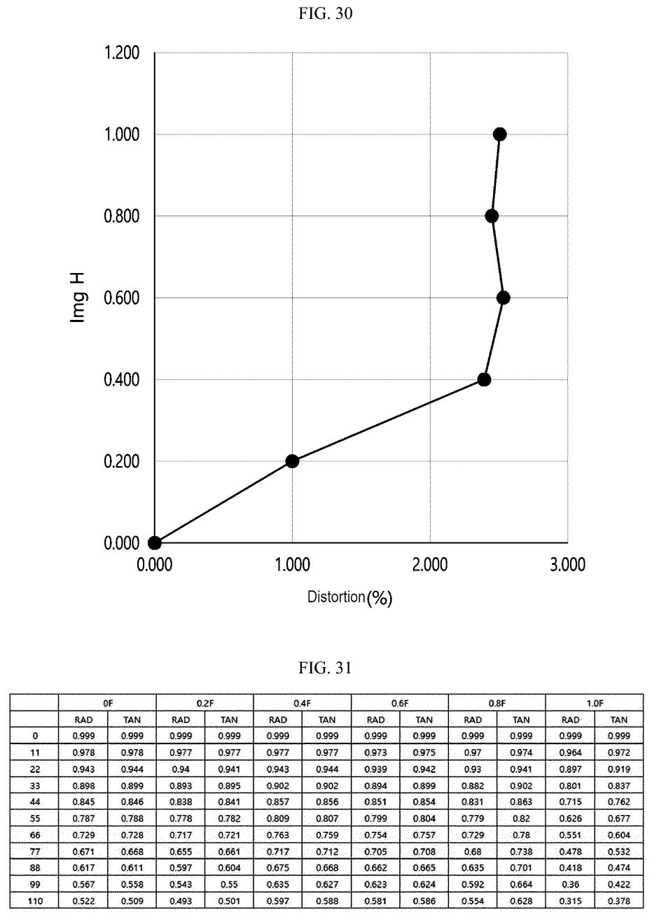

FIG. 24 shows the numerical values of items applied to the above equations in the optical system 1000 and optical module 2000 according to the second embodiment, FIG. 25 shows slop angles for each position of the first to fifth lenses in the optical system according to the second embodiment, FIG. 26 shows lens intervals for each position of the first to fifth lenses in the optical system according to the second embodiment, FIG. 27 shows lens thickness for each position of the first to fifth lenses in the optical system according to the second embodiment, FIG. 28 shows Sag values for each position of the first to fifth lenses in the optical system according to the second embodiment, FIG. 29 shows aspherical coefficient values of the optical system 1000 according to the second embodiment, and FIG. 30 shows graphs showing degrees of distortion of an optical system and an optical module according to the second embodiment. FIG. 31 shows a table for describing MTF characteristics of an optical system and an optical module according to the second embodiment.

Referring to FIG. 25, it may be seen that in the optical system and optical module according to the second embodiment, the first to fifth lenses are formed at different slope angles for each position.

Additionally, it may be seen that the slope angles of the first to fifth lenses gradually increases as they move away from the optical axis. That is, it may be seen that the first to fifth lenses have the largest slope angle at the end of the effective diameter.

Additionally, it may be seen that the slope angles of the first to fifth lenses increases as they move away from the optical axis. That is, it may be seen that the curvature of the overall lens surface of the first to fifth lenses increases as they move away from the optical axis.

Additionally, it may be seen that at least one lens among the first to fifth lenses includes a region where the sign of the slope angle changes. That is, it may be seen that at least one lens among the first to fifth lenses includes a critical point.

Additionally, it may be seen that at least one lens among the first to fifth lenses includes a region where the size of the slope angle decreases.

Referring to FIG. 26, it may be seen that in the optical system and optical module according to the second embodiment, the first to fifth lenses are formed at different lens intervals at each position.

Additionally, at least one lens among the first to fifth lenses may include a region where the size of the lens interval is reduced. For example, an interval between the second lens and the third lens, an interval between the third lens and the fourth lens, and an interval between the fourth lens and the fifth lens may include a region in which the size of the lens interval decreases.

Additionally, at least one lens among the first to fifth lenses may include a region where the size of the lens interval increases. For example, the interval between the second lens and the third lens and the interval between the third lens and the fourth lens may include a region where the size of the lens interval increases.

Additionally, the region where the size of the lens interval decreases may be larger than the region where the size of the lens interval of at least one lens among the first to fifth lenses increases. For example, the interval between the first lens and the second lens, the interval between the second lens and the third lens, and the interval between the fourth lens and the fifth lens may be larger in a region where the size of the lens interval decreases than a region where the size of the lens interval increases.

Additionally, the region where the lens interval increases in at least one lens among the first to fifth lenses may be larger than the region where the lens interval decreases. For example, the interval between the third lens and the fourth lens may be larger in a region where the size of the lens interval increases than a region where the size of the lens interval decreases.

Additionally, at least one lens among the first to fifth lenses may include only a region where the size of the lens interval decreases. For example, the interval between the first lens and the second lens and the interval between the fourth lens and the fifth lens may include only a region where the size of the lens interval decreases.

Referring to FIG. 27, it may be seen that in the optical system and optical module according to the second embodiment, the first to fifth lenses are formed with different lens thicknesses at each position.

Additionally, at least one lens among the first to fifth lenses may include a region where the lens thickness decreases. For example, the first lens, the third lens, and the fourth lens may include a region where the lens thickness decreases.

Additionally, at least one lens among the first to fifth lenses may include a region where the lens thickness increases. For example, the second lens and the fifth lens may include a region where the lens thickness increases.

Additionally, the region where lens thickness decreases may be larger than the region where lens thickness increases in at least one lens among the first to fifth lenses. For example, the region where the thickness of the first lens, the third lens, and the fourth lens decreases may be larger than the region where the thickness increases.

Additionally, the region where the lens thickness increases in at least one lens among the first to fifth lenses may be larger than the region where the lens thickness decreases. For example, the region where the thickness of the second lens increases may be larger than the region where the thickness decreases.

Additionally, at least one lens among the first to fifth lenses may include only a region where the lens thickness decreases. For example, the first lens, the third lens, and the fourth lens may include only a region where the lens thickness decreases.

Additionally, at least one lens among the first to fifth lenses may include only a region where the lens thickness increases. For example, the second lens may include only a region where the lens thickness increases.

Referring to FIG. 28, it may be seen that the optical system and optical module according to the second embodiment are formed with the first to fifth lenses having different Sag values at each position.

Additionally, at least one lens among the first to fifth lenses may include a region where the size of the Sag value increases. For example, the first and second surfaces of the first lens, the third and fourth surfaces of the second lens, the fifth and sixth surfaces of the third lens, the seventh and eighth surfaces of the fourth lens, and the ninth and tenth surfaces of the fifth lens may include a region where the Sag value increases.

Additionally, the region where the Sag value increases in at least one lens among the first to fifth lenses may be larger than the region where the Sag value decreases. For example, the first and second surfaces of the first lens, the third and fourth surfaces of the second lens, the fifth and sixth surfaces of the third lens, the seventh and eighth surfaces of the fourth lens, and the ninth and tenth surfaces of the fifth lens may be larger than the region in which the Sag value increases may be larger region in which the Sag value increases than in which the Sag value decreases.

Additionally, at least one lens among the first to fifth lenses may include only a region where the Sag value increases. For example, the first and second surfaces of the first lens, the third and fourth surfaces of the second lens, the fifth and sixth surfaces of the third lens, the seventh and eighth surfaces of the fourth lens, and the ninth and tenth surfaces of the fifth lens may include only regions in which the Sag values increases.

In the optical system 1000 and the optical module 2000 according to the second embodiment, the numerical values in FIG. 24 may satisfy at least one of Equations 1 to 35. In detail, the optical system 1000 and the optical module 2000 according to the second embodiment may satisfy all of Equations 1 to 35 above.

Accordingly, it may be seen that the optical system and optical module according to the second embodiment may have low distortion characteristics as shown in FIG. 30.

Additionally, it may be seen that the optical system and optical module according to the second embodiment may have improved MTF characteristics as shown in FIG. 31.

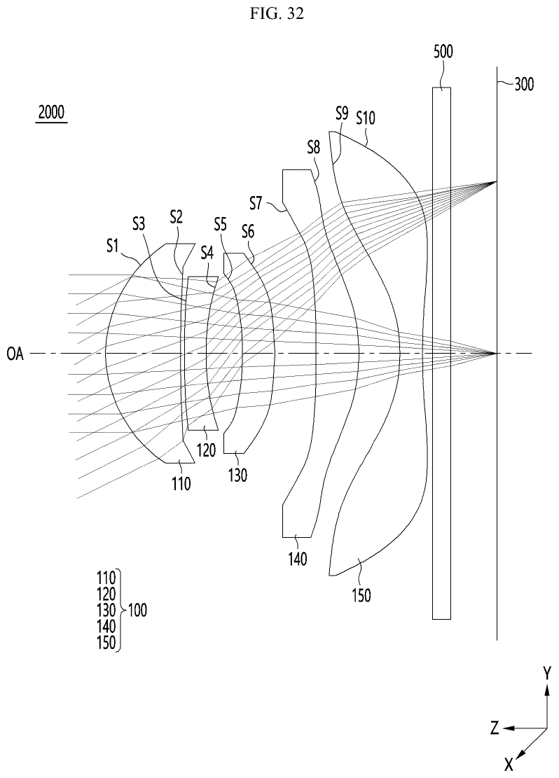

Hereinafter, the optical system 1000 and the optical module 2000 according to the third embodiment will be described in more detail with reference to FIGS. 32 to 42.

Referring to FIG. 32, the optical system 1000 and optical module 2000 according to the third embodiment may include five lenses.

In detail, the optical system 1000 and the optical module 2000 according to the third embodiment include a first lens 110, a second lens 120, a third lens 130, a fourth lens 140, a fifth lens 150, and an image sensor unit 300 arranged sequentially from the object side toward the sensor side. The first lens 110, the second lens 120, the third lens 130, the fourth lens 140, and the fifth lens 150 may be arranged sequentially disposed along the optical axis of the optical system 1000 and spaced apart from each other.

Additionally, a filter unit 500 may be disposed between the plurality of lenses 110, 120, 130, 140, and 150 and the image sensor unit 300. The filter unit 500 may be disposed between the fifth lens 150 and the image sensor unit 300.

Additionally, the optical system 1000 according to the third embodiment may include an aperture stop (not shown). The aperture stop may be disposed between the first lens 110 and the second lens 120. Alternatively, the sensor-side surface of the first lens 110 may serve as an aperture stop.

The first to fifth lenses 110, 120, 130, 140, and 150 according to the third embodiment each may have a radius of curvature, thickness, distance, refractive index, and Abbe number.

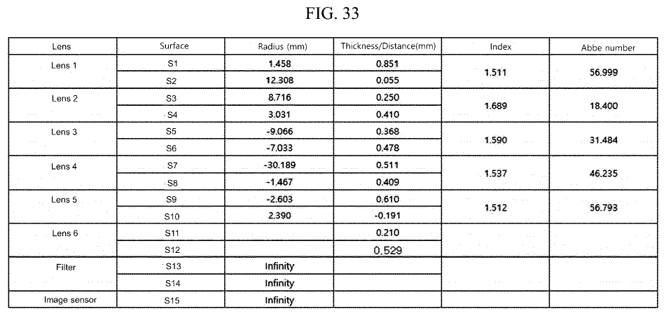

In detail, the radius of curvature, thickness, distance, refractive index, and Abbe number of the first to fifth lenses 110, 120, 130, 140, and 150 according to the third embodiment may be as shown in FIG. 33.

Referring to FIGS. 32 and 33, in the optical system 1000 according to the third embodiment, the first lens 110 may have positive refractive power on the optical axis. The first surface S1 of the first lens 110 may be convex with respect to the object side on the optical axis, and the second surface S2 may be concave with respect to the sensor side on the optical axis. The first lens 110 may have an overall meniscus shape convex from the optical axis toward the object. The first surface S1 may be an aspherical surface, and the second surface S2 may be an aspherical surface.

The second lens 120 may have negative refractive power on the optical axis. The third surface S3 of the second lens 120 may be convex with respect to the object-side surface on the optical axis, and the first lens 110 may have positive refractive power on the optical axis. The first surface S1 of the first lens 110 may be convex with respect to the object side on the optical axis, and the second surface S2 may be concave with respect to the sensor side on the optical axis. The first lens 110 may have an overall meniscus shape convex toward the object side on the optical axis. The first surface S1 may be an aspherical surface, and the second surface S2 may be an aspherical surface.

The second lens 120 may have positive (+) refractive power on the optical axis. The third surface S3 of the second lens 120 may be convex with respect to the object side on the optical axis, and the fourth surface S4 may be concave with respect to the sensor side on the optical axis. The second lens 120 may have an overall meniscus shape convex toward the object side on the optical axis. The third surface S3 may be an aspherical surface, and the fourth surface S4 may be an aspherical surface.

The third lens 130 may have negative refractive power on the optical axis. The fifth surface S5 of the third lens 130 may be concave with respect to the object side on the optical axis, and the sixth surface S6 may be convex with respect to the sensor side on the optical axis. The third lens 130 may have a meniscus shape that is generally convex toward the sensor side. The fifth surface S5 may be an aspherical surface, and the sixth surface S6 may be an aspherical surface.

The fourth lens 140 may have positive (+) refractive power on the optical axis. The seventh surface S7 of the fourth lens 140 may be concave with respect to the object side on the optical axis, and the eighth surface S8 may be convex with respect to the sensor side on the optical axis. The fourth lens 140 may have an overall meniscus shape convex toward the sensor side on the optical axis. The seventh surface S7 may be an aspherical surface, and the eighth surface S8 may be an aspherical surface.

The fifth lens 150 may have negative refractive power on the optical axis. The ninth surface S9 of the fifth lens 150 may be concave with respect to the object side on the optical axis, and the tenth surface S10 may be concave with respect to the sensor side on the optical axis. The fifth lens 150 may have an overall shape where both sides are concave on the optical axis.

At least one of the ninth surface S9 and the tenth surface S10 may include a freeform surface. In detail, the ninth surface S9 and the tenth surface S10 may include freeform surfaces. That is, the fifth lens 150 may be a freeform lens.

The free-form shape of the fifth lens 150 may be defined by the Sag value calculated by Equation D.

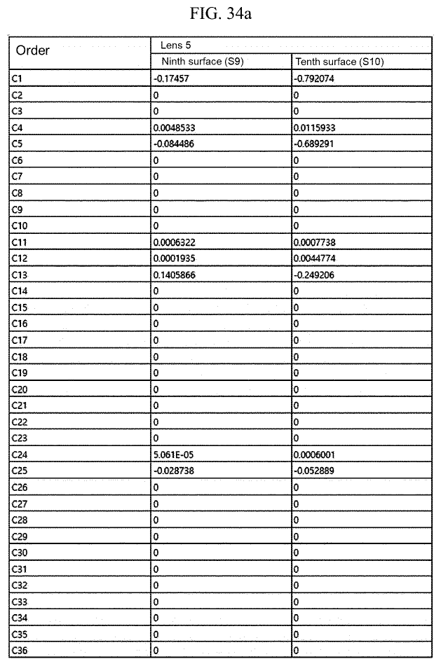

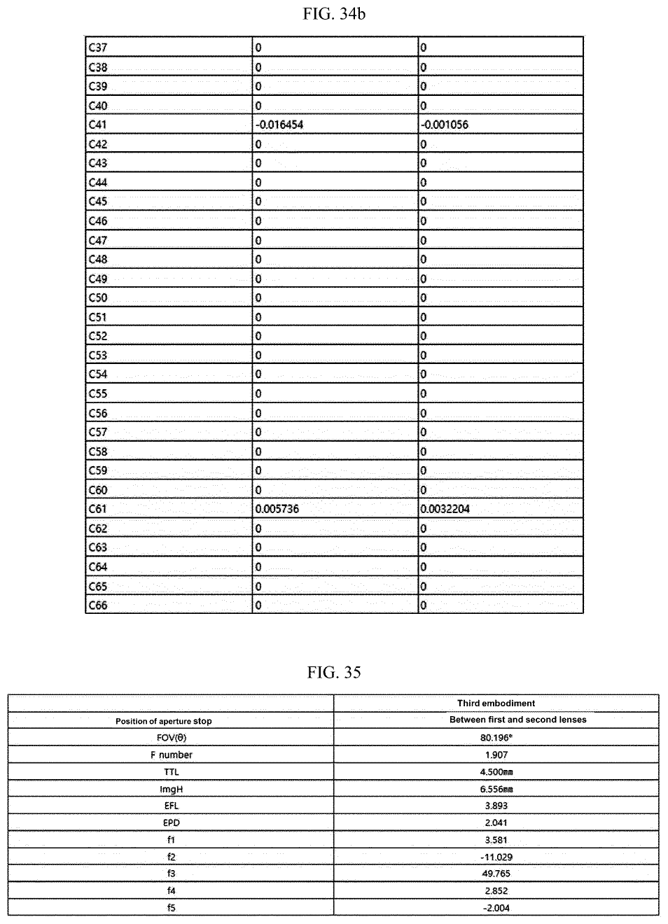

In detail, the fifth lens 150 may include orders in which the Zernike coefficients of FIG. 34 have a value of 0 and orders that have a value other than 0.

In detail, in FIG. 12, the fifth lens 150 may manufacture the fifth lens by setting all orders having Sin θ and Cos θ to a value of 0, and adjusts some of the orders having Cos 2nθ to non-zero values.

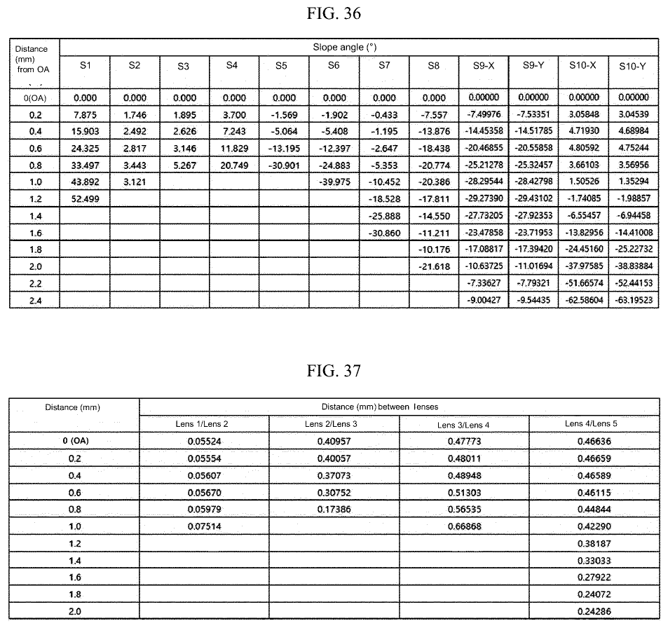

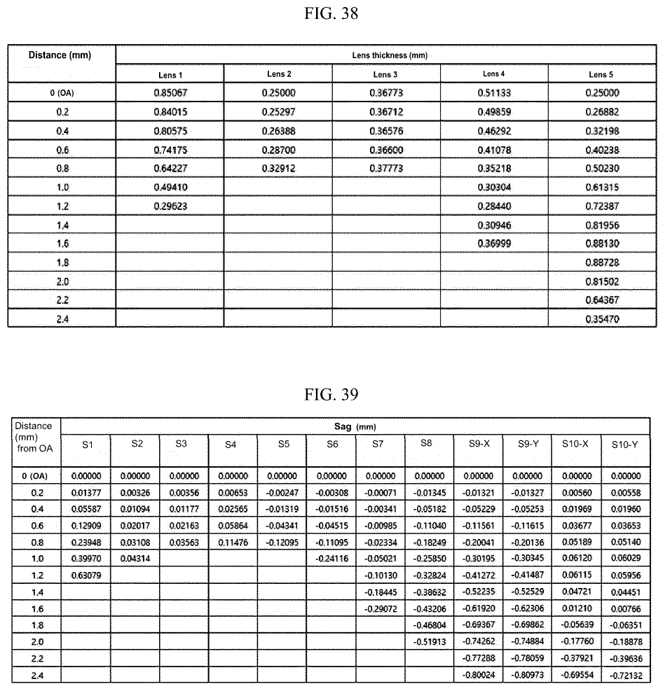

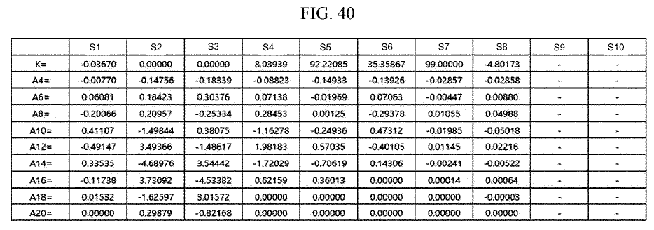

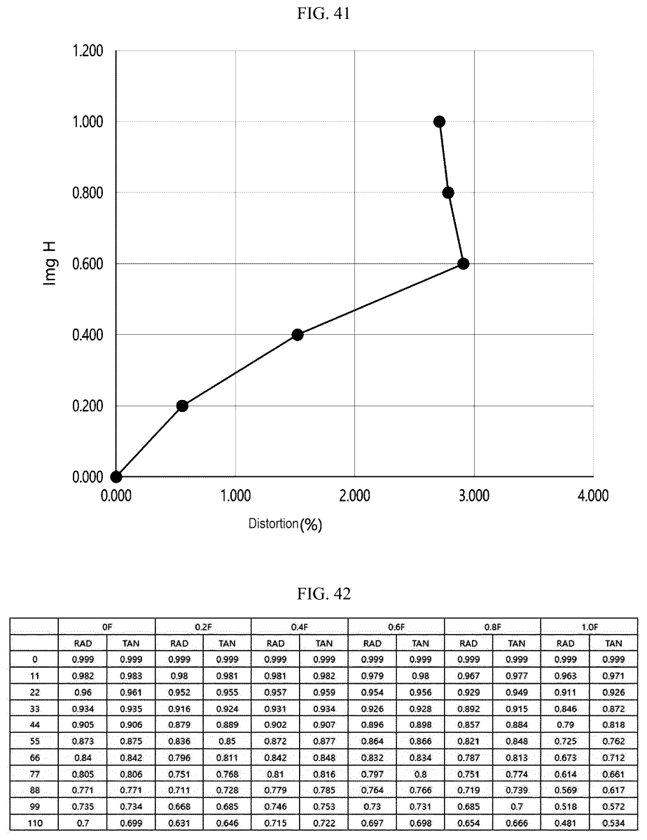

FIG. 35 shows the numerical values of items applied to the above equations in the optical system 1000 and optical module 2000 according to the third embodiment, FIG. 36 shows slop angles for each position of the first to fifth lenses in the optical system according to the third embodiment, FIG. 37 shows lens intervals for each position of the first to fifth lenses in the optical system according to the third embodiment, FIG. 38 shows lens thickness for each position of the first to fifth lenses in the optical system according to the third embodiment, FIG. 39 shows Sag values for each position of the first to fifth lenses in the optical system according to the third embodiment, FIG. 40 shows aspherical coefficient values of the optical system 1000 according to the third embodiment, FIG. 41 shows a graph illustrating a degree of distortion of the optical system and the optical module according to the third embodiment, and FIG. 42 shows a table for describing MTF characteristics of the optical system and the optical module according to the third embodiment.

Referring to FIG. 36, it may be seen that in the optical system and optical module according to the third embodiment, the first to fifth lenses are formed at different slope angles for each position.

Additionally, it may be seen that the slope angle of the first to fifth lenses gradually increases as they move away from the optical axis. That is, it may be seen that the first to fifth lenses have the largest slope angle at the end of the effective diameter.

Additionally, it may be seen that the slope angle of the first to fifth lenses increases as they move away from the optical axis. That is, it may be seen that the curvature of the overall lens surface of the first to fifth lenses increases as they move away from the optical axis.

Additionally, it may be seen that at least one lens among the first to fifth lenses includes a region where the sign of the slope angle changes. That is, it may be seen that at least one lens among the first to fifth lenses includes a critical point.

Additionally, it may be seen that at least one lens among the first to fifth lenses includes a region where the size of the slope angle decreases.

Referring to FIG. 37, it may be seen that in the optical system and optical module according to the third embodiment, the first to fifth lenses are formed at different lens intervals for each position.

Additionally, at least one lens among the first to fifth lenses may include a region where the size of the lens interval is reduced. For example, the interval between the second lens and the third lens and the interval between the fourth lens and the fifth lens may include a region where the size of the lens interval decreases.

Additionally, at least one lens among the first to fifth lenses may include a region where the size of the lens interval increases. For example, the interval between the first lens and the second lens and the interval between the third lens and the fourth lens may include a region where the size of the lens interval increases.

Additionally, the region where the size of the lens interval decreases may be larger than the region where the size of the lens interval of at least one lens among the first to fifth lenses increases. For example, the interval between the second lens and the third lens and the interval between the fourth lens and the fifth lens may be larger in a region where the size of the lens interval decreases than a region where the size of the lens interval increases.

Additionally, the region where the lens interval increases in at least one lens among the first to fifth lenses may be larger than the region where the lens interval decreases. For example, the interval between the first lens and the second lens and the interval between the third lens and the fourth lens may be larger in a region where the size of the lens interval increases than a region where the size of the lens interval decreases.

Additionally, at least one lens among the first to fifth lenses may include only a region where the size of the lens interval decreases. For example, the interval between the second lens and the third lens may include only a region where the size of the lens interval decreases.

Additionally, at least one lens among the first to fifth lenses may include only a region where the size of the lens interval increases. For example, the interval between the first lens and the second lens and the interval between the third lens and the fourth lens may include only a region where the size of the lens interval increases.

Referring to FIG. 38, it may be seen that in the optical system and optical module according to the third embodiment, the first to fifth lenses are formed with different lens thicknesses at each position.

Additionally, at least one lens among the first to fifth lenses may include a region where the lens thickness decreases. For example, the first lens, the fourth lens, and the fifth lens may include a region where the lens thickness decreases.

Additionally, at least one lens among the first to fifth lenses may include a region where the lens thickness increases. For example, the second lens and the third lens may include a region where the lens thickness increases.

Additionally, the region where lens thickness decreases may be larger than the region where lens thickness increases in at least one lens among the first to fifth lenses. For example, the region where the thickness of the first lens and the fourth lens decreases may be larger than the region where the thickness increases.

Additionally, the region where the lens thickness increases in at least one lens among the first to fifth lenses may be larger than the region where the lens thickness decreases. For example, the region where the thickness of the second lens increases may be larger than the region where the thickness decreases.

Additionally, at least one lens among the first to fifth lenses may include only a region where the lens thickness decreases. For example, the first lens and the fourth lens may include only a region where the lens thickness decreases.

Additionally, at least one lens among the first to fifth lenses may include only a region where the lens thickness increases. For example, the second lens may include only a region where the lens thickness increases.

Referring to FIG. 39, it may be seen that the optical system and optical module according to the third embodiment are formed with the first to fifth lenses having different Sag values at each position.

Additionally, at least one lens among the first to fifth lenses may include a region where the size of the Sag value increases. For example, the first and second surfaces of the first lens, the third and fourth surfaces of the second lens, the fifth and sixth surfaces of the third lens, the seventh and eighth surfaces of the fourth lens, and the ninth and tenth surfaces of the fifth lens may include a region where the Sag value increases.

Additionally, the region where the Sag value increases in at least one lens among the first to fifth lenses may be larger than the region where the Sag value decreases. For example, the first and second surfaces of the first lens, the third and fourth surfaces of the second lens, the fifth and sixth surfaces of the third lens, the seventh and eighth surfaces of the fourth lens, and the ninth and tenth surfaces of the fifth lens may be larger than the region in which the Sag value increases may be larger region in which the Sag value increases than in which the Sag value decreases.

Additionally, at least one lens among the first to fifth lenses may include only a region where the Sag value increases. For example, the first and second surfaces of the first lens, the third and fourth surfaces of the second lens, the fifth and sixth surfaces of the third lens, the seventh and eighth surfaces of the fourth lens, and the ninth and tenth surfaces of the fifth lens may include only regions in which the size of the Sag value increases.

In the optical system 1000 and the optical module 2000 according to the third embodiment, the numerical value in FIG. 35 may satisfy at least one of Equations 1 to 35. In detail, the optical system 1000 and the optical module 2000 according to the third embodiment may satisfy all of Equations 1 to 35 above.

Accordingly, it may be seen that the optical system and optical module according to the third embodiment have low distortion characteristics as shown in FIG. 41.

Additionally, it may be seen that the optical system and optical module according to the third embodiment have improved MTF characteristics as shown in FIG. 42.

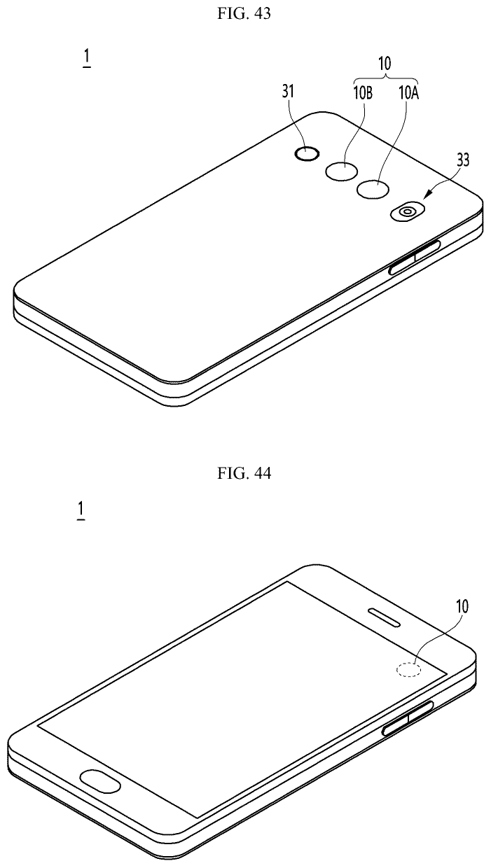

FIGS. 43 and 44 are diagrams showing a camera module according to an embodiment applied to a mobile terminal.

Referring to FIG. 43, the mobile terminal 1 may include a camera module 10 provided on the rear side.

The camera module 10 may include an image capturing function. Additionally, the camera module 10 may include at least one of an auto focus, zoom function, and OIS function.

The camera module 10 may process image frames of still images or videos obtained by the image sensor 300 in shooting mode or video call mode. The processed image frame may be displayed on a display unit (not shown) of the mobile terminal 1 and may be stored in a memory (not shown).

For example, the camera module 10 may include a first camera module 10A and a second camera module 10B. At this time, at least one of the first camera module 10A and the second camera module 10B may include the optical system 1000 described above. Accordingly, the camera module 10 may have a slim structure and may photograph subjects at various magnifications.

Additionally, the mobile terminal 1 may further include an autofocus device 31. The autofocus device 31 may include an autofocus function using a laser. The autofocus device 31 may be mainly used in conditions where the autofocus function using the image of the camera module 10 is deteriorated, for example, at a distance of 10 m or less or in a dark environment. The autofocus device 31 may include a light emitting unit including a vertical cavity surface emitting laser (VCSEL) semiconductor device, and a light receiving unit such as a photo diode that converts light energy into electrical energy.

Additionally, the mobile terminal 1 may further include a flash module 33. The flash module 33 may include a light emitting device inside that emits light. The flash module 33 may emit light in the visible light wavelength band. For example, the flash module 33 may emit white light or light of a color similar to white. However, the embodiment is not limited thereto, and the flash module 33 may emit light of various colors. The flash module 33 may be operated by operating a camera of a mobile terminal or by user control.

Additionally, referring to FIG. 44, the mobile terminal 1 may include a camera module 10 provided on the front.

In detail, the mobile terminal 1 may have a camera module 10 disposed in the screen display region on the front of the mobile terminal 1. That is, the mobile terminal 1 may have a camera module 10 disposed in a display region where a screen is displayed.

That is, the camera module 10 may be an under-display camera in which the camera module is placed below the display of the mobile terminal 1.

When the camera module is applied as an under-display camera, the screen region may be expanded by removing a separate bezel region for placing the camera, and there is no need to apply a punch hole design that creates a camera hole.

The features, structures, effects, etc. described in the embodiments above are included in at least one embodiment of the present invention and are not necessarily limited to only one embodiment. Furthermore, the features, structures, effects, etc. illustrated in each embodiment may be combined or modified and implemented in other embodiments by a person with ordinary knowledge in the field to which the embodiments belong. Accordingly, the contents related to such combinations and modifications should be interpreted as being included in the scope of the invention.

In addition to, although the embodiments have been mainly described above, this is only an example and does not limit the present invention, and those of ordinary skill in the field to which the present invention pertains will appreciate that various modifications and applications not illustrated above are possible without departing from the essential characteristics of this embodiment. For example, each component specifically shown in the embodiment may be modified and implemented. And differences related to these modifications and applications should be interpreted as being included in the scope of the present invention as defined in the accompanying claims.

1. An optical module comprising:
a sensor; and
an optical system including a first lens, a second lens, a third lens, a fourth lens, and a fifth lens arranged sequentially along an optical axis from an object side to a sensor side,
wherein an object-side surface of the second lens has a convex shape on the optical axis,
wherein at least one of an object-side and sensor-side surfaces of the fifth lens includes a freeform surface,
wherein the fifth lens satisfies the following Equation A:
$$\vert max Sag\_O \_x \_ 5 \vert \neq \vert max Sag\_O \_y \_ 5 \vert \qquad [ Equation A ]$$
(In Equation A, max |Sag_O_x_5| means an absolute value of a maximum Sag value in an X-axis direction on the object-side surface of the fifth lens, and max |Sag_O_y_5| means an absolute value of a maximum Sag value in a Y-axis direction on the object-side surface of the fifth lens);
wherein the optical system satisfies the following Equations 1 to 3:
$$60 ° \leq FOV \leq 90 ° \qquad [ Equation 1 ]$$
(FOV in Equation 1 means field of view)
$$0.50 \leq TTL / ImgH \leq 1. \qquad [ Equation 2 ]$$
(In Equation 2, TTL means a distance in the optical axis direction from a vertex of an object-side surface of the first lens to an image surface of the image sensor unit, and ImgH means twice a diagonal distance from the image surface of the image sensor unit overlapping the optical axis to a 1.0 field region of the image sensor);
$$CA\_O \_x < CA\_O \_ 5 \qquad [ Equation 3 ]$$
(In Equation 3, CA_O_x means an effective diameter of an object-side surface of a lens closest to an aperture stop among lenses between the aperture stop and the sensor, and CA_O_5 means an effective diameter of the object-side surface of the fifth lens).

2. The optical module of claim 1,
wherein the fifth lens satisfies Equation B below:
$$0.1 µm \leq max \vert Sag\_O \_x \_ 5 \vert - max \vert Sag\_O \_y \_ 5 \vert \leq 5 µm . \qquad [ Equation B ]$$

3. The optical module of claim 1,
wherein the third lens satisfies Equation 4 below:
$$15 ° < \vert SA1\_O \_ 3 \vert \leq 40 ° , \\ 20 ° < \vert SA1\_S \_ 3 \vert \leq 50 ° \qquad [ Equation 4 ]$$
(In Equation 4, SA1_O_3 means a slope angle between a normal line of an object-side surface and the optical axis at any point on the object-side surface at a distance in a range of 75% to 95% of a distance from the optical axis of the third lens to an effective diameter, and SA1_S_3 means a slope angle between a normal line of a sensor-side surface and the optical axis at any point on the sensor-side surface at a distance ranging from 75% to 95% of a distance from the optical axis of the third lens to an effective diameter).

4. The optical module of claim 1,
wherein the fourth lens satisfies Equation 5 below:
$$20 ° < \vert SA1\_O \_ 4 \vert \leq 50 ° , \\ 15 ° < \vert SA1\_S \_ 4 \vert \leq 40 ° \qquad [ Equation 5 ]$$
(In Equation 5, SA1_O_4 means a slope angle between a normal line of an object-side surface and the optical axis at any point on the object-side surface at a distance in a range of 75% to 95% of a distance from the optical axis of the fourth lens to an effective diameter, and SA1_S_4 means a slope angle between a normal line of a sensor-side surface and the optical axis at any point on the sensor-side surface at a distance ranging from 75% to 95% of a distance from the optical axis of the fourth lens to an effective diameter).

5. The optical module of claim 1,
wherein the fifth lens satisfies Equation 6 below:
$$15 ° \leq \vert SA1\_O \_x \_ 5 \vert \leq 30 ° , \\ 15 ° \leq \vert SA1\_O \_y \_ 5 \vert \leq 30 ° \qquad [ Equation 6 ]$$
(In Equation 6, SA1_O_x_5 means a slope angle between a normal line and the optical axis at any point on the object-side surface at a distance in the range of 75% to 95% of a distance from the optical axis to an effective diameter in the X-axis direction from the optical axis of the fifth lens, and SA1_O_y_5 means an angle between a normal line and the optical axis at any point on the object-side surface at a distance in the range of 75% to 95% of a distance from the optical axis to an effective diameter in the Y-axis direction from the optical axis of the fifth lens).

6. The optical module of claim 1,
wherein the fifth lens satisfies Equation 12 below:
$$550 µm \leq max \vert Sag\_O \_x \_ 4 \vert - min \vert Sag\_O \_x \_ 4 \vert \leq 800 µm , 450 µmmm \leq max \vert Sag\_O \_y \_ 4 \vert - min \vert Sag\_O \_y \_ 4 \vert \leq 750 µm \qquad [ Equation 12 ]$$
(In Equation 12, max |Sag_O_x_4| means an absolute value of a maximum Sag value in a X-axis direction from an object-side surface of the fourth lens, min |Sag_O_x_4| means an absolute value of a minimum Sag value that is not zero in the X-axis direction on the object-side surface of the fourth lens, max |Sag_O_y_4| means an absolute value of a maximum Sag value in a Y-axis direction from the object-side surface of the fourth lens, and min |Sag_O_y_4| means an absolute value of a minimum Sag value that is not zero in the Y-axis direction on the object-side surface of the fourth lens).

7. The optical module of claim 1,
wherein the third lens and the fourth lens satisfy Equation 21 below:
$$max \vert SA\_O \_ 4 \vert > max \vert SA\_O \_ 3 \vert , max \vert SA\_S \_ 4 \vert < max \vert SA\_S \_ 3 \vert , max \vert SA\_O \_ 4 \vert < 50 ° , \\ max \vert SA\_S \_ 4 \vert < 40 ° \qquad [ Equation 21 ]$$
(In Equation 21, max |SA_O_3| means a maximum slope angle between a normal line and the optical axis at any point on an object-side surface in a distance range from the optical axis of the third lens to an effective diameter, max |SA_S_3| means a maximum slope angle between a normal line and the optical axis at any point on a sensor-side surface in a distance range from the optical axis of the third lens to an effective diameter, max |SA_O_4| means a maximum slope angle between a normal line and the optical axis at any point on an object-side surface in a distance range from the optical axis of the fourth lens to an effective diameter, and max |SA_S_4| means a maximum slope angle between a normal line and the optical axis at any point on a sensor-side surface in a distance range from the optical axis of the fourth lens to an effective diameter).

8. The optical module of claim 1,
wherein a sensor-side surface of the second lens has a concave shape on the optical axis,
wherein the first lens and the second lens satisfy Equation 24 below:
$$P\_ 1 sign \neq P\_ 2 sign , V\_ 1 > V\_ 2 , 10 < V 2 < 50 < V 1 , N\_ 1 < N\_ 2 \qquad [ Equation 24 ]$$
(In Equation 24, the P_1 sign is the refractive power sign of the first lens having a positive (+) or negative (−) sign, P_2 sign is a refractive power sign of the second lens having a positive (+) or negative (−) sign, V_1 is an Abbe number of the first lens, V_2 is an Abbe number of the second lens, N_1 is a refractive index of the first lens, and N_2 is a refractive index of the second lens).

9. The optical module of claim 1,
wherein the fifth lens satisfies Equation 35 below:
$$0.8 mm < D\_mx \_ 5 / I < 1.5 mm \qquad [ Equation 35 ]$$
(In Equation 41, D_mx_5/I means a distance in the optical axis direction from a point having an absolute value of a maximum Sag value on the sensor-side surface of the fifth lens to the image surface of the image sensor unit).

10. The optical module of claim 1,
wherein the sensor-side surface of the fifth lens includes a critical point located at a distance of more than 30% to 50% of an effective radius of the fifth lens from the optical axis.

11. The optical module of claim 1,
wherein an object-side surface of the third lens has a concave shape on the optical axis.

12. The optical module of claim 1,
wherein the first lens and the fifth lens have different thicknesses at the optical axis.

13. The optical module of claim 1,
wherein the second lens has positive refractive power on the optical axis.

14. An optical module comprising:
an optical system having first to fifth lenses sequentially arranged along an optical axis from an object side to a sensor side,
wherein an object-side surface of the first lens has a convex shape on the optical axis,
wherein a sensor-side surface of the first lens has a concave shape on the optical axis,
wherein an object-side surface of the second lens has a convex shape on the optical axis,
wherein the second lens has positive refractive power on the optical axis, and
wherein object-side and sensor-side surfaces of the fifth lens have a free-form shape on the optical axis.

15. The optical module of claim 14,
wherein a field of view of the optical system is in a range of 60 degrees to 90 degrees.

16. The optical module of claim 15,
wherein a distance in an optical axis direction from a vertex of the object-side surface of the first lens to an image surface of an image sensor unit is TTL,
wherein ImgH is twice a diagonal distance from the image surface of the image sensor overlapping the optical axis to a 1.0 field region of the image sensor,
wherein the following Equation satisfies:
$$0.50 \leq TTL / ImgH \leq 1. .$$

17. The optical module of claim 14,
wherein a sensor-side surface of the second lens has a concave shape on the optical axis.

18. The optical module of claim 14,
wherein an object-side surface of the third lens has a concave shape on the optical axis,
wherein the second lens and the fifth lens have different thicknesses at the optical axis.

19. The optical module of claim 14,
wherein the third and fourth lenses have positive refractive power on the optical axis,
wherein the third lens and the fourth lens satisfy the following equation:
$$max \vert SA\_O \_ 4 \vert > max \vert SA\_O \_ 3 \vert , max \vert SA\_S \_ 4 \vert < max \vert SA\_S \_ 3 \vert , max \vert SA\_O \_ 4 \vert < 50 ° , \\ max \vert SA\_S \_ 4 \vert < 40 ° \qquad [ Equation ]$$
(In the equation, max |SA_O_3| means a maximum slope angle between a normal line and the optical axis at any point on an object-side surface in a distance range from the optical axis of the third lens to an effective diameter, and max |SA_S_3| means a maximum slope angle between a normal line and the optical axis at any point on a sensor-side surface in a distance range from the optical axis of the third lens to an effective diameter, max |SA_O_4| means a maximum slope angle between a normal line and the optical axis at any point on an object-side surface in a distance range from the optical axis of the fourth lens to an effective diameter, and max |SA_S_4| means a maximum slope angle between a normal line and the optical axis at any point on a sensor-side surface in a distance range from the optical axis of the fourth lens to an effective diameter).

20. The optical module of claim 14,
wherein the fifth lens has negative refractive power on the optical axis,
wherein the fifth lens has a meniscus shape convex toward an object on the optical axis,
wherein the object-side surface and the sensor-side surface of the fifth lens have critical points.
